(19) United States
(12) Patent Application Publication
(10) Pub. No.: US 2026/0030509 A1
(43) Pub. Date: Jan. 29, 2026

(54) TECHNIQUES FOR SYNERGISTIC PLANNING, IMITATION, AND REINFORCEMENT LEARNING FOR ROBOT CONTROL

(71) Applicant: NVIDIA CORPORATION, Santa Clara, CA (US)

(72) Inventors: Calen Reed GARRETT, Seattle, WA (US); Ajay Uday MANDLEKAR, Cupertino, CA (US); Dieter FOX, Seattle, WA (US); Animesh GARG, Berkeley, CA (US); Zihan ZHOU, Santa Clara, CA (US)

(21) Appl. No.: 19/180,750

(22) Filed: Apr. 16, 2025

Related U.S. Application Data
(60) Provisional application No. 63/676,223, filed on Jul. 26, 2024.

(51) Int. Cl. G06N 3/092; B25J 9/16; G06F 9/48; G06N 3/0464

(52) U.S. Cl. CPC G06N 3/092; B25J 9/163; G06F 9/4881; G06N 3/0464

(57) ABSTRACT

The disclosed method for training one or more robot control models includes performing, based on one or more demonstration trajectories of a robot performing one or more skills associated with a task, one or more training operations to generate one or more first trained machine learning models for controlling the robot; and performing one or more reinforcement learning operations using the one or more first trained machine learning models to generate one or more second trained machine learning models for controlling the robot.

### CROSS-REFERENCE TO RELATED APPLICATIONS

This application claims priority benefit of the United States Provisional Patent Application titled, “SYNERGISTIC PLANNING, IMITATION, AND REINFORCEMENT FOR LONG-HORIZON MANIPULATION,” filed on Jul. 26, 2024, and having Ser. No. 63/676,223. The subject matter of this related application is hereby incorporated herein by reference.

### BACKGROUND

### Technical Field

Embodiments of the present disclosure relate generally to computer science, artificial intelligence and machine learning and, more specifically, to techniques for synergistic planning, imitation, and reinforcement learning for robot control.

### Description of the Related Art

Robot control generally refers to the use of automated systems, such as robotic arms, to execute movement and manipulation tasks in a variety of settings. In robot control, a control algorithm is employed to determine the commands that drive a robotic end-effector (e.g., a robot gripper) through a desired motion, often relying on sensor data, such as force feedback, camera images, joint encoders, and/or the like. Typical robot control tasks can include precisely positioning an end-effector, grasping and manipulating objects, tracking desired trajectories (e.g., a set of robot motions), and reacting to changes in the environment. In some cases, robot control is integrated into larger systems that handle multi-step procedures—such as assembling products, dispensing materials, or performing inspection—where each step can require distinct control strategies or tool configurations. Moreover, certain robotic tasks include one or more skills that have to be sequenced or combined, such as picking an item from a conveyor, inspecting the item under a camera, reorienting the item in the gripper, and then placing the item accurately onto a moving fixture.

Conventional approaches for robotic control oftentimes use reinforcement learning (RL). In an RL-based robot control system, the robot explores various robot actions in a given environment and a control policy, which is a machine learning model for controlling the robot, is refined based on a numerical reward that indicates successful outcomes. For example, an RL-based robot control system can assign a numerical reward for beneficial behaviors (e.g., accurately inserting a peg into a hole) and could assign a lower or zero reward for unproductive or failed behaviors. Through repeated trials and by tracking the rewards, the RL algorithm gradually refines the robot control policy. For example, if the robot presses down at an incorrect angle, the robot could receive a low reward, prompting a policy update to avoid that action in future attempts. On the other hand, other conventional approaches for robot control use imitation learning (e.g., behavior cloning (BC)), which is based on demonstrations. For example, a human operator could provide examples (e.g., demonstrations) of the correct way to manipulate an object, and the robot can then clone or replicate the demonstrated actions to learn a robot control policy. As a specific example, the human operator could teleoperate the robot end-effector to align and insert a component into a slot. The robot state-action pairs from the demonstrations (e.g., sensor readings at each step and the corresponding operator actions) can be recorded. A robot policy can then be trained to replicate the recorded actions when facing similar inputs (e.g., object positions or force readings). In some examples, demonstrations can be collected using virtual reality controllers or exoskeleton suits, giving the robot examples of human-like dexterous maneuvers.

One drawback of the RL-based approaches for robot control is that RL-based robot control systems often need carefully designed rewards. Those rewards can be challenging to design when the robot handles multiple subtasks or interacts carefully with objects the robot touches or pushes. In such scenarios, an RL agent may struggle to discover effective actions unless the rewards provide specific guidance for each stage of the task.

One drawback of BC-based approaches for robot control is training a robot control policy through BC typically requires access to extensive and high-quality demonstration data. Whenever the demonstrations fail to cover certain variations or edge cases, the learned robot control policy can become unreliable or unable to handle new situations, limiting the adaptability of robot when new or slightly altered subtasks are introduced.

In addition, both RL and BC can require carefully designing rewards or collecting many example demonstrations to teach the robot what to perform. Accordingly, these approaches are oftentimes unsuitable for training robot control policies that control robots to perform long horizon robotic tasks that can include interactions with various object properties or intricate sequences of actions.

As the foregoing illustrates, what is needed in the art are more effective techniques for robot control.

### SUMMARY

According to some embodiments, a computer implemented method for training one or more robot control models includes performing, based on one or more demonstration trajectories of a robot performing one or more skills associated with a task, one or more training operations to generate one or more first trained machine learning models for controlling the robot. The method further includes performing one or more reinforcement learning operations using the one or more first trained machine learning models to generate one or more second trained machine learning models for controlling the robot.

According to some embodiments, a computer-implemented method for training one or more robot control models includes scheduling a plurality of workers based on a sampling strategy for sampling workers to execute and a queue that stores indications of workers that require scheduling. The method further includes executing the plurality of workers based on the scheduling to generate a plurality of trained machine learning models for controlling a robot to perform a plurality of skills associated with a task.

Further embodiments provide, among other things, non-transitory computer-readable storage media storing instructions and systems configured to implement the method set forth above.

At least one technical advantage of the disclosed techniques relative to the prior art is that the disclosed techniques combine task-and-motion planning (TAMP) with behavior cloning and reinforcement learning (RL) in a synergistic framework that overcomes limitations of either approach alone. Unlike conventional RL techniques which require finely tuned, dense reward functions, the disclosed techniques restrict RL to predefined handoff sections determined by TAMP. The restriction simplifies reward design by allowing sparse, success-based rewards to be used. Another advantage of the disclosed techniques is that, rather than learning entire task behaviors end-to-end, the disclosed techniques use TAMP to handle routine skills included in the task, while reinforcement learning is used to fine-tune residual corrections for more challenging skills. The disclosed techniques also reduce the need for large, high-quality demonstration datasets by limiting the scope of behavior cloning to a subset of skills, where skills that are easier to model are delegated to TAMP. Yet another advantage of the disclosed techniques is that, by leveraging a scheduler that coordinates multiple TAMP workers and selectively allocates RL training opportunities to skills that are ready for training, the disclosed techniques permit scalable training for long-horizon tasks. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 is a more detailed illustration of the trajectory recorder of FIG. 1, according to various embodiments;

FIG. 4A illustrates how the model trainer of FIG. 1 trains policy models, according to various embodiments;

FIG. 4B illustrates how the model trainer of FIG. 1 trains residual models using a scheduler, according to various embodiments;

FIG. 5 is a more detailed illustration of the robot control application of FIG. 1, according to various embodiments;

FIG. 6 is a flow diagram of method steps for training robot control models, according to various embodiments;

FIG. 7 is a flow diagram of method steps for generating demonstration data, according to various embodiments;

FIG. 8 is a flow diagram of method steps for training policy models, according to various embodiments;

FIG. 9 is a flow diagram of method steps for training residual models using the scheduler, according to various embodiments;

FIG. 10 is the flow diagram of method steps for training a residual model using reinforcement learning, according to various embodiments; and

FIG. 11 is the flow diagram of method steps for controlling a robot, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for controlling robots using a task and motion planner (TAMP) and robot control models that are trained using behavior cloning and reinforcement learning. The robot control models are machine learning models, such as neural networks, that process robot states and generate robot actions to perform at least part of a robotic skill. Each robot control model includes a policy model that generates robot actions and a residual model that generates modifications to the robot actions output by the policy model. In some embodiments, TAMP is used to generate demonstration data based on user inputs. Given a robotic task and a demonstration skillset, TAMP divides the task into various skills and checks whether the current skill is in the demonstration skillset, which includes the set of skills for which one or more robot control models need to be trained. Whenever the skill is not in the demonstration skillset, TAMP causes the robot to perform the skill until reaching a handoff section, which implies that the next skill is in the demonstration skillset. Then, the robot receives one or more user inputs, which cause the robot to perform the skill in the demonstration skillset. A trajectory recorder records the trajectory of the robot, which is stored in the demonstration data. The foregoing process continues until the task is complete. In some embodiments, a model trainer uses the demonstration data to train the policy models included in the robot control models. For each skill in demonstration skillset, the model trainer uses a trajectory for that skill included in the demonstration data to train a policy model. In various embodiments, the robot control model generates robot actions which are applied within a simulator. The simulator generates the next robot state and roll-out data based on the robot actions. A loss calculator calculates a behavior cloning loss based on the roll-out data and the demonstration data, which includes robot states and robot actions, and the trajectory. The model trainer then iteratively updates the parameters of the policy model based on the calculated losses until one or more stopping criteria are met. The model trainer then trains another policy model for another skill until training for all skills in the demonstrations skillset have completed. In various embodiments, the model trainer uses the robot control model with the trained policy models to train residual models using reinforcement learning. During the reinforcement learning, the robot control model generates robot actions which are applied to the simulator. The simulator generates the next robot states and the roll-out data based on the robot actions. The loss calculation module uses a reinforcement learning reward calculator to calculate a reinforcement learning reward based on robot actions, robot state, and robot actions generated using the trained policy model. The model trainer then uses a reinforcement learning module to iteratively update the parameters of the residual model based on the calculated rewards until one or more stopping criteria are met. The reinforcement learning module can use a reward that includes a Kullback-Leibler (KL) divergence term that limits deviations of robot actions generated by the robot control model from the robot actions generated by the previously trained policy model. Once the residual models for all skills in the demonstration skillset are trained, the robot control models, which each include a trained policy model that generates robot actions and a trained residual model that generates modifications to the robot actions, can be used along with TAMP to process sensor data and a task, and generate actions to cause a robot to perform at least part of the task that includes multiple skills.

In some embodiments, the model trainer uses a scheduler to schedule training of robot control models during the reinforcement learning. In various embodiments, the scheduler receives a sampling strategy, one or more workers, and a status queue. Each worker includes a TAMP environment that performs skills not in the demonstration skillset by default and reports a section request to the status queue whenever TAMP reaches a handoff section. Each status queue element includes a worder identifier (ID) and a section ID. To begin with, the scheduler pops the status queue. The scheduler then checks whether a section from the status queue is acceptable based on the sampling strategy. Whenever the section is determined not to be acceptable, the scheduler resets the worker, thereby skipping reinforcement learning for that particular section. Otherwise, the scheduler interacts with the model trainer, which performs reinforcement learning to train the residual model for the section. The reinforcement learning continues until the worker indicates to the scheduler the completion of the skill, at which point the worker uses TAMP to perform a next skill, if any, until a handoff section is reached and the worker reports another section request to the status queue. The scheduler also checks whether the status queue is empty. Whenever the scheduler determines that the status queue is not empty, the scheduler pops the status queue again and repeats the process. Whenever the scheduler determines that the status queue is empty, the model trainer stores the trained residual models.

The robot control techniques of the present disclosure have many real-world applications. For example, the robot control techniques could be used to control a physical robot in a real-world environment or a simulated robot in a virtual environment. As another example, the robot control techniques could be used to control a robot to perform a task which requires multiple skills.

The above examples are not in any way intended to be limiting. As persons skilled in the art will appreciate, as a general matter, the robot control techniques described herein can be implemented in any suitable application.

### System Overview

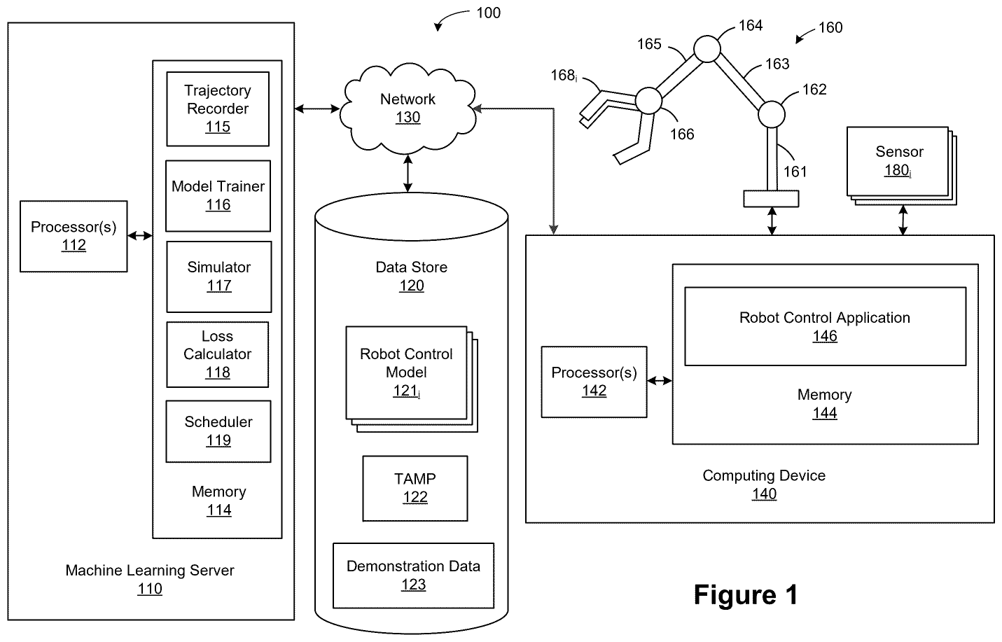

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a trajectory recorder 115, a model trainer 116, a simulator 117, a loss calculator 118, and a scheduler 119. Data store 120 stores, without limitation, one or more robot control models 121ᵢ, a task and motion planner (TAMP) 122, and demonstration data 123. Computing device 140 includes, without limitation, processor(s) 142 and a memory 144. Memory 144 includes, without limitation, a robot control application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

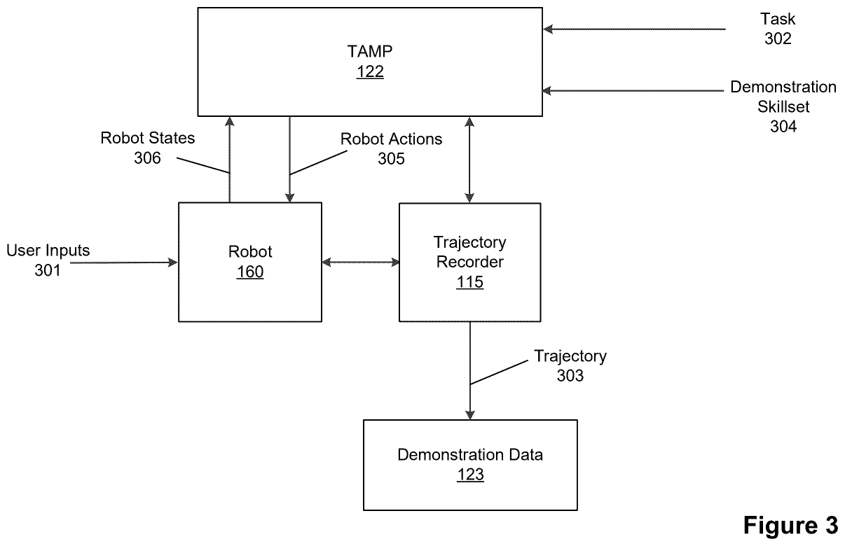

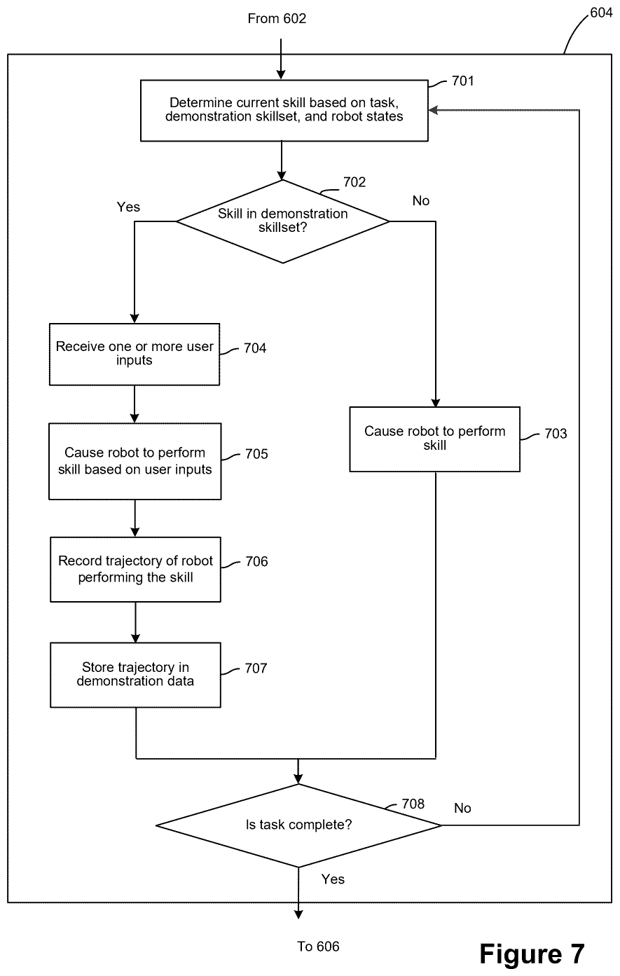

As shown, trajectory recorder 115 executes on one or more processors 112 of machine learning server 110 and is stored in system memory 114 of machine learning server 110. In various embodiments, trajectory recorder 115 is an application that records one or more trajectories of robot 160 based on one or more user inputs received from one or more I/O devices (not shown) to generate demonstration data 123. Demonstration data 123, which can be stored in data store 120 or elsewhere (e.g., in memory 114), includes trajectories (e.g., time-ordered sequences of robot end-effector, positions, velocities, accelerations) and related information describing how a robot performs at least part of a task. Trajectory recorder 115 is described in greater detail below in conjunction with FIGS. 3 and 7.

As shown, simulator 117 is an application that executes on one or more processors 112 of machine learning server 110 and is stored in system memory 114 of machine learning server 110. In various embodiments, simulator 117 is an application that processes robot actions generated by robot control models 121 and generates the next robot states and roll-out data.

As shown, loss calculator 118 is an application that executes on one or more processors 112 of machine learning server 110 and is stored in system memory 114 of machine learning server 110. In various embodiments, loss calculator 118 is an application that calculates a behavior cloning loss based on demonstration data 123 and the roll-out data from simulator 117. In some embodiments, loss calculator 118 generates a reinforcement learning reward based on roll-out data using simulator 117.

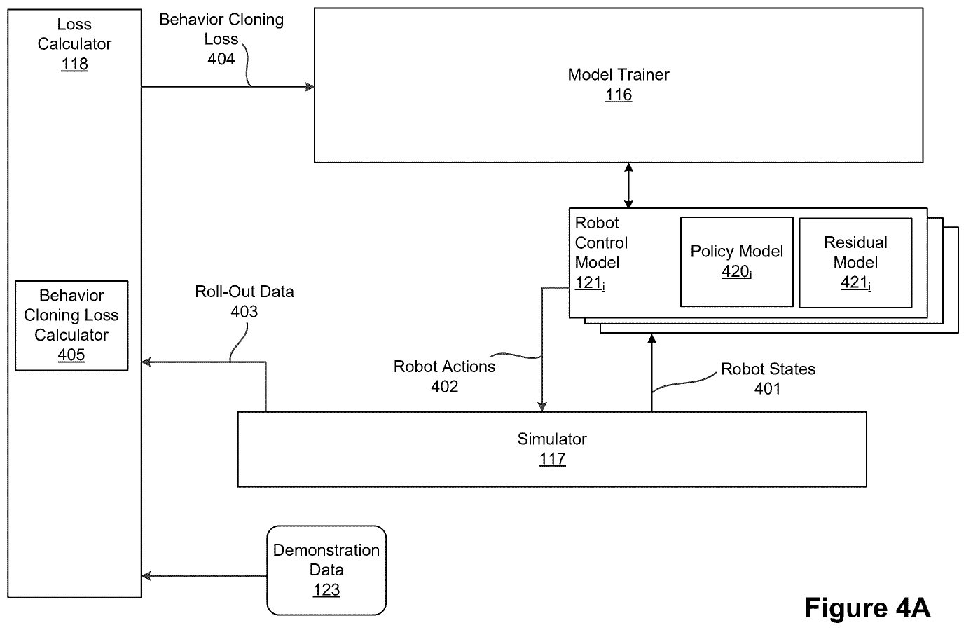

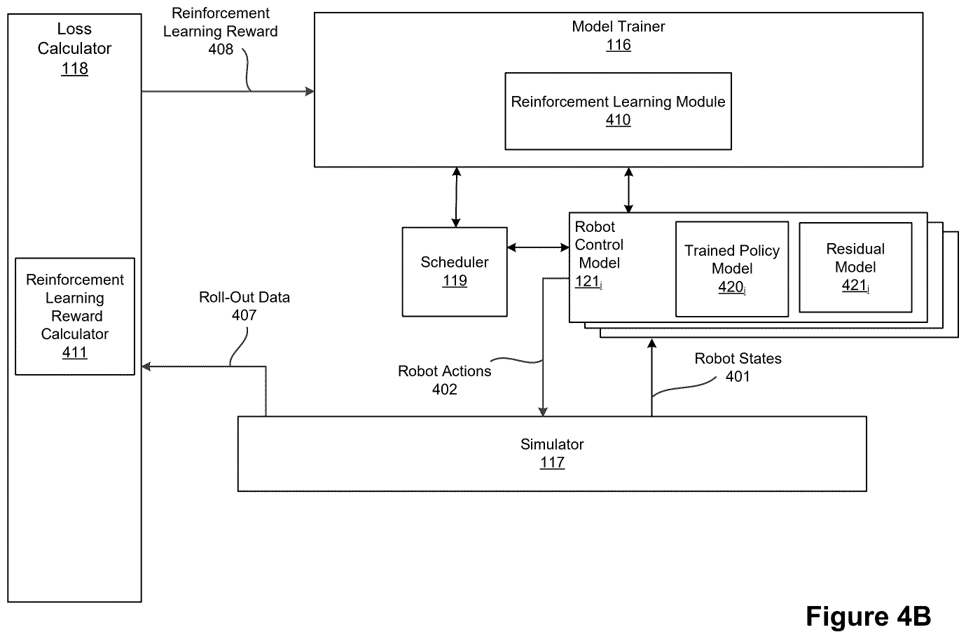

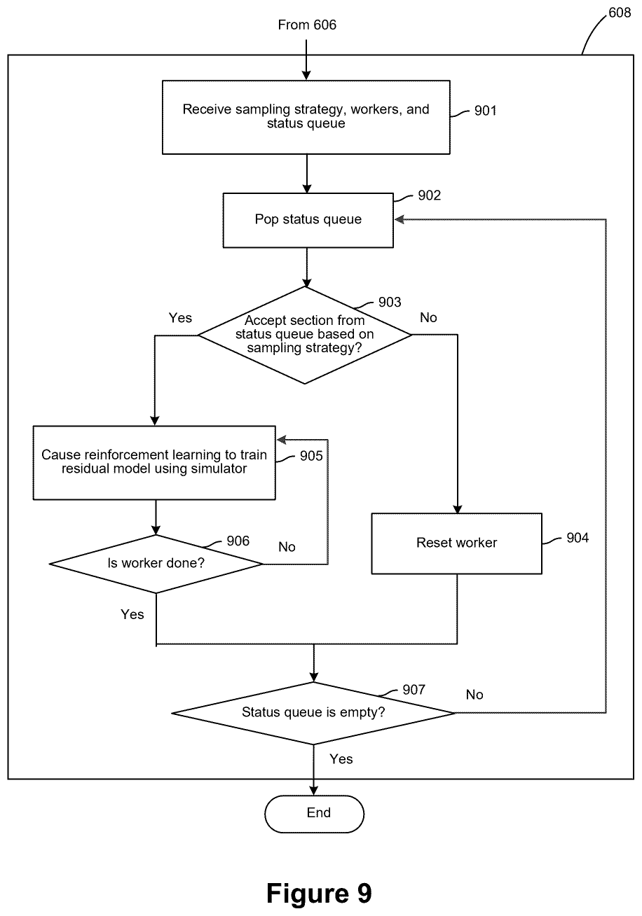

As shown, scheduler 119 is an application that executes on one or more processors 112 of machine learning server 110 and is stored in system memory 114 of machine learning server 110. In various embodiments, scheduler 119 is an application that interacts with model trainer 116 and robot control models 121 to schedule reinforcement learning to train robot control models 121 using simulator 117. Scheduler 119 is described in greater detail below in conjunction with FIGS. 4B and 9.

As shown, TAMP 122 is an application that is stored in data store 120. Although shown as being stored in data store 120 in FIG. 1, TAMP 122 can be stored in memory 114 during the training of robot control models 121 or can be stored in memory 144 during inference. In various embodiments, TAMP 122 receives a task and a demonstration skillset via one or more I/O devices. The demonstration skillset includes one or more skills that have to be performed to complete the task. One or more skills included in the demonstration skillset are performed using at least one of user inputs or one or more trained robot control models 121. TAMP 122 generates robot actions to perform a skill that is not part of the demonstration skillset. Once TAMP 122 determines a handoff section has been reached based on robot states corresponding to a skill in the demonstration skillset, TAMP 122 defers robot action generation to user inputs or to an appropriate trained robot control model 121.

As shown, model trainer 116 is an application that executes on one or more processors 112 of machine learning server 110 and is stored in a system memory 114 of machine learning server 110. Although shown as distinct from loss calculator 118 for illustrative purposes, in some embodiments, functionality of the loss calculator 118 and the model trainer 116 can be combined into a single application.

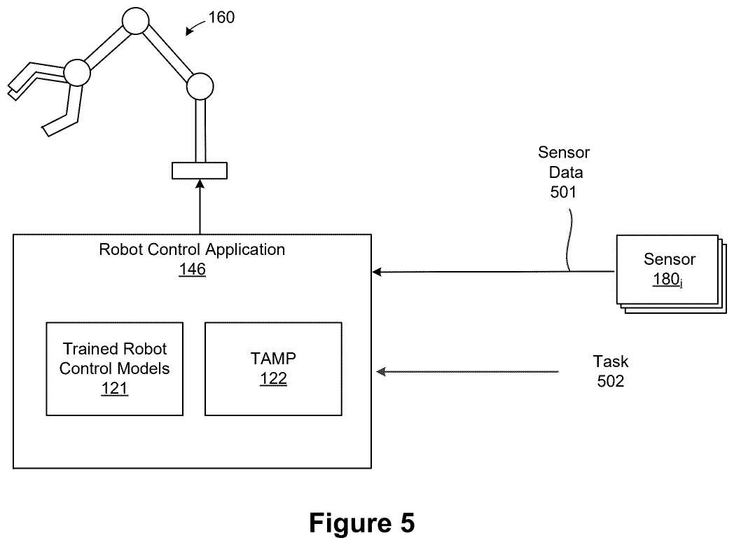

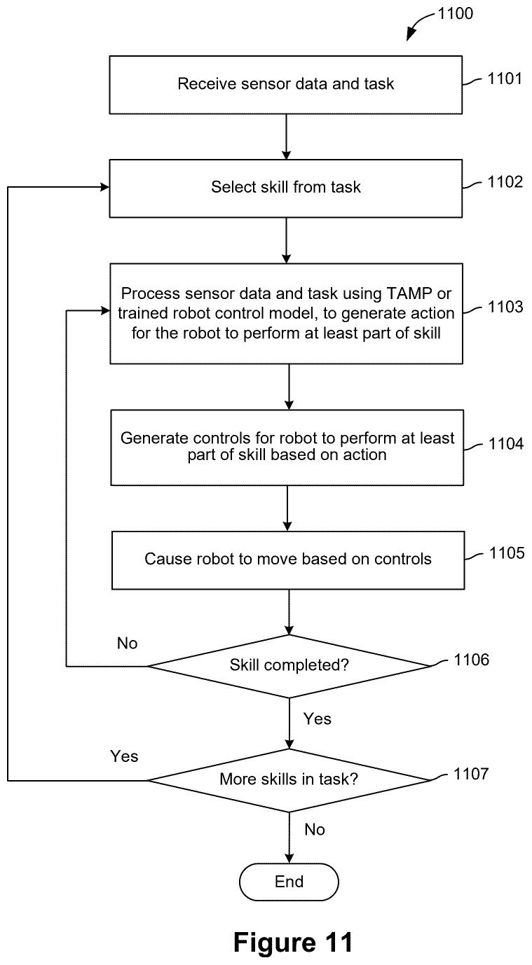

In some embodiments, model trainer 116 is configured to train one or more machine learning models, including robot control models 121ᵢ (referred to herein collectively as robot control models 121 and individually as a robot control model 121). Robot control models 121 are machine learning models, such as neural networks, which are trained to generate actions for a robot (e.g., robot 160) to perform at least part of a task based on one or more observations acquired via one or more sensors 180ᵢ (referred to herein collectively as sensors 180 and individually as a sensor 180), as discussed in greater detail below in conjunction with FIGS. 5 and 11. For example, in at least one embodiment, sensors 180 can include one or more cameras, one or more RGB-D cameras (e.g., cameras using time-of-flight sensors), such as a wrist-mounted RGB-D camera, one or more LiDAR sensors, any combination thereof, etc. Techniques for training robot control models 121, based on demonstration data 123 and using reinforcement learning are discussed in greater detail herein in conjunction with at least FIGS. 4A and 6-10. Robot control models 121 can be stored in data store 120. Although shown as being stored in data store 120 in FIG. 1, robot control models 121 can be stored in memory 114 during training or can be stored in memory 144 during inference. In some embodiments, the same computing device(s) can be used for training and inference after training, rather than the separate machine learning server 110 and computing device 140. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, a robot control application 146 that uses robot control models 121 and TAMP 122 is stored in data store 120 accessed over network 130, and executes on processor(s) 142, of computer device 140. Once trained, trained robot control models 121 can be deployed, such as via robot control application 146, to control a physical robot in a real-world environment, such as robot 160 to perform one or more skills as a part of a task. In various embodiments, trained robot control models 121 are deployed for use with virtual environments, such as in a simulator (not shown), where a virtual model of robot 160 is simulated within a virtual environment, such as a digital twin or a simulation platform. In the virtual deployment, robot control application 146 interfaces with a virtual representation of robot 160, which can enable testing, validation, and refinement of robot plans. Memory 144 and the processor(s) 142 can be similar to memory 114 and processor(s) 112 of machine learning server 110, described above. Robot control application 146 is discussed in greater detail below in conjunction with FIG. 5.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168ᵢ (referred to herein collectively as fingers 168 and individually as a finger 168) that can be controlled to grasp an object. For example, in at least one embodiment, robot 160 can include a locked wrist and multiple (e.g., four) fingers. Although an example robot 160 is shown for illustrative purposes, in at least one embodiment, techniques disclosed herein can be applied to control any suitable robot.

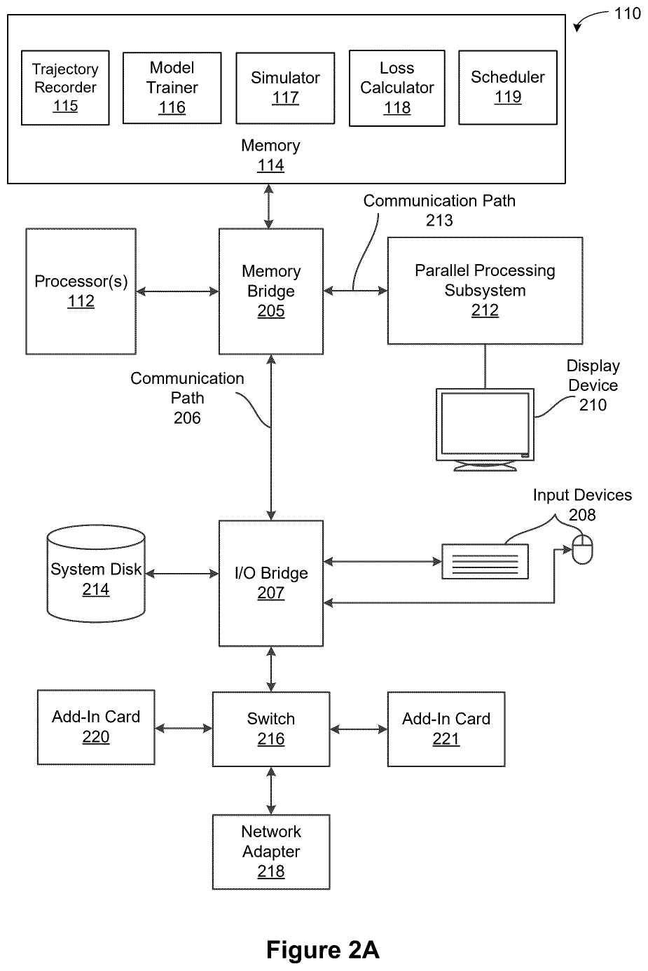

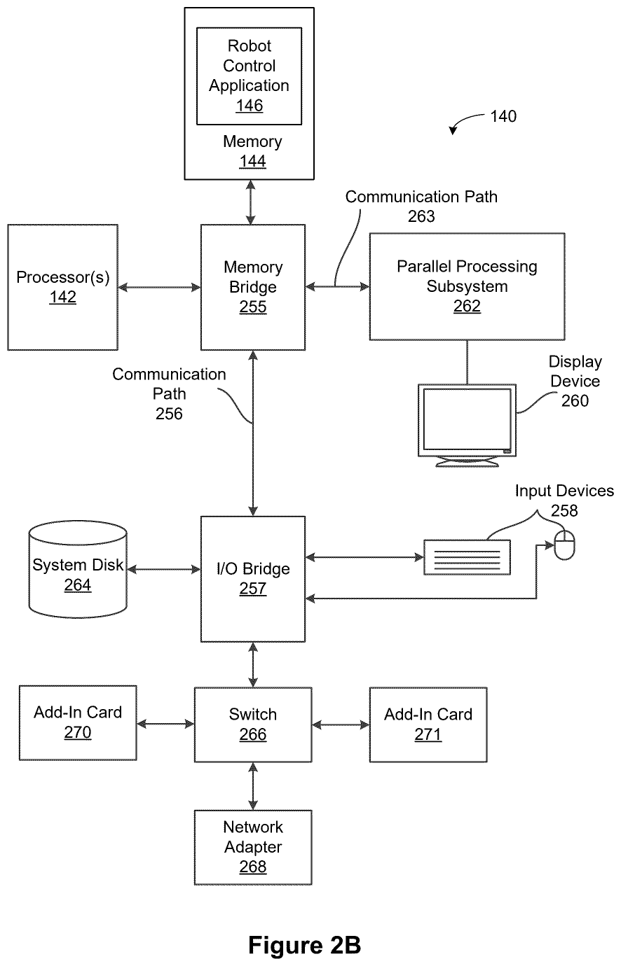

FIG. 2A is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, trajectory recorder 115, model trainer 116, simulator 117, loss calculator 118, and scheduler 119. Although described herein primarily with respect to trajectory recorder 115, model trainer 116, simulator 117, loss calculator 118, and scheduler 119, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes robot control application 146. Although described herein primarily with respect to robot control application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Demonstration Data Generation Using User Inputs

FIG. 3 is a more detailed illustration of the trajectory recorder 115 of FIG. 1, according to various embodiments. As shown, TAMP 122 receives task 302 and demonstration skillset 304 and generates robot actions 305 based on robot states 306 to cause robot 160 to perform a skill which is not in demonstration skillset 304. Once TAMP 122 determines reaching a handoff section based on robot states 306 corresponding to a skill in demonstration skillset 304, robot 160 receives user inputs 301 that cause robot 160 to perform a skill in demonstration skillset 304. Trajectory recorder 115 interacts with TAMP 122 and robot 160 and records trajectory 303, which is stored in demonstration data 123.

TAMP 122 is an application which processes robot states 306 and generates robot actions 305. In various embodiments, TAMP 122 receives a task 302 and demonstration skillset 304. TAMP 122 processes robot states 306, task 302, and a demonstration skillset and generates robot actions 305 to cause robot 160 to perform a skill which is not in demonstration skillset 304 until reaching a hand off section. For example, TAMP 122 could generate actions 305 causing robot 160 to move an arm from the resting position to a coffee machine or to retrieve a coffee cup from a known location. TAMP 122 determines reaching a handoff section based on robot states 306 corresponding to a skill which is not in demonstration skillset 304. For example, pouring hot water into a coffee filter or placing a capsule into a coffee machine, which are skills that require fine manipulation or force control, could be delegated to a trained robot control model 121 or a user via teleoperation. Upon determining a handoff section, TAMP 122 pauses generating robot actions 305 and triggers a transition to using at least one of a trained robot control model 121 or user inputs 301 to perform the skill which is not in demonstration skillset 304. After the skill is completed, TAMP 122 resumes generating robot actions 305 based on robot states 306 until reaching the next hand off section. TAMP 122 continues the process until task 302 is complete. In some embodiments, TAMP 122 includes a model-based approach for synthesizing long-horizon robot behavior. TAMP 122 integrates discrete (e.g., symbolic) planning with continuous (e.g., motion) planning to plan hybrid discrete-continuous robot actions 305. In some embodiments, TAMP 122 uses a model of robot actions that a planner can apply, and the robot actions 305 modify the current robot states 306. Using the model, TAMP 122 can search over the space of plans to find a sequence of robot actions 305 and the associated parameters that satisfies a skill. In some embodiments, each task 302 includes a series of alternating TAMP sections and handoff sections, where TAMP 122 delegates generating robot actions 305 to a trained agent It. The sections are TAMP-gated (e.g., the sections are chosen at the discretion of the TAMP 122) and typically include skills that are difficult to automate with model-based planning. In various embodiments, a TAMP-gated policy learning problem can be modelled as a series of Markov Decision Processes (MDPs),

$$ℳ := {( 𝒮 , 𝒜 , T , \{ {r}^{i} \} , \{ {p}_{0}^{i} \} , γ )}_{i = 1}^{N} ,$$

where N is the number of MDPs (each corresponding to a handoff section), [symbol] and [symbol] are the state and action space, T is the transition dynamics, rⁱ(s) and

$${p}_{0}^{i}$$

are the i-th reward function and initial state distribution, and γ is the discount factor. The start and end of each handoff section is chosen by TAMP 122. That is, TAMP 122 determines the initial state distribution p₀ⁱ for each handoff section, and the reward function rⁱ(s). In various embodiments, demonstration skillset 304 includes one or more skills that are impractical to manually model. For example, skills such as gently stirring a cup without spilling or attaching a lid that requires precise alignment and force application could be included in demonstration skillset 304 due to fine-grained dynamics and sensitivity to small variations. During data generation, whenever TAMP 122 determines reaching a hand off section, robot 160 performs the skill in demonstration skillset 304 based on user inputs 301. In various embodiments, user inputs 301 include teleoperation commands provided by a human operator using various input devices, such as a joystick, a VR controller, a kinesthetic teaching interface, and/or the like.

Trajectory recorder 115 is an application that records trajectory 303 (e.g., demonstration trajectory) of robot 160, which is generated when user inputs 301 cause robot 160 to perform a skill in the demonstration skillset 304. Trajectory recorder 115 then stores trajectory 303 in demonstration data 123. In various embodiments, demonstration data 123 can be represented as

$$𝒟 = \{ \{ {( {s}_{t} , {a}_{t} )}_{t = 1}^{{H}_{i}} , {g}_{i} \} \} ,$$

where sₜ∈ [symbol] , aₜ∈ [symbol] and Hᵢ is the horizon, and gᵢ is the handoff section of the i-th trajectory 303. In some examples, [symbol] is a 7-dimensional continuous action space that models 6-degree of freedom delta movement of the end-effector of robot 160 along with 1 dimension for finger control, and [symbol] is modeled as a normal distribution with a scheduled standard deviation.

### Training Policy Models Using Demonstration Data

FIG. 4A illustrates how the model trainer 116 of FIG. 1 trains policy models 420, according to various embodiments. As shown, robot control model 121 includes, without limitation, a policy model 420 and a residual model 421. In operation, policy model 420 of robot control model 121 generates robot actions 402 based on robot states 401. Robot states 401 are applied to simulator 117 which generates the next robot states 401 and roll-out data 403. Loss calculator 118 uses a behavior cloning loss calculator 405 to calculate a behavior cloning loss 404 based on roll-out data 403 and demonstration data 123. Model trainer 116 updates the parameters of policy model 420 based on behavior cloning loss 404. In various embodiments, the training of robot control models 121 is carried out in two steps. In the first step, model trainer 116 iteratively trains one or more policy models 420 included in robot control models 121 using behavior cloning. The first step is described in conjunction with FIG. 4A. In the second step, model trainer 116 trains one or more residual models 421 included in robot control models 121 using reinforcement learning. The training of residual models 421 is described in greater detail in conjunction with FIG. 4B.

Robot control models 121 are machine learning models, such as neural networks, which process robot states 401 and generate robot actions 402. In some embodiments, each robot control model 121 is associated with a skill from demonstration skillset 304 and is configured to generate robot actions 402 that guide robot 160 in performing that skill. Although described herein primarily with respect to robot control models that are each associated with a single skill, in some embodiments, a robot control model can be trained to perform multiple skills. Robot control models 121 include, without limitation, policy models 420 and residual models 421. In some examples, each policy model 420 can be represented by a base policy π_{ϕ}(s) which maps robot states 401 to robot actions 402 and is parameterized by parameters ϕ. Residual model 421 can also be represented by a residual policy

$${π}_{θ}^{+} ( s )$$

which maps robot states 401 to robot actions 402 and is parameterized by parameters θ. Robot control model 121 then maps robot states 401 to robot actions 402 based on the base policy and the residual policy. Accordingly, the residual policy generates a delta action that is a modification/correction to the base action generated by the base policy. For example, robot control model 121 can be represented by a policy

$${π}_{ϕ} ( s ) = {π}_{ϕ} ( s ) + {π}_{θ}^{+} ( s ) ,$$

which is parameterized by both parameters ϕ,θ. In some examples, robot control models 121 are convolutional neural networks. In some embodiments, the residual policy shares the same action space as the base policy but is initialized close to zero. Although described herein primarily with respect to training separate base and residual policies, in some embodiments, a single policy can be trained using behavior cloning and re-trained using reinforcement learning in a manner similar to the training of the base and residual policies.

Simulator 117 processes robot actions 402 and generates robot states 401 and roll-out data 403. In various embodiments, simulator 117 includes a robot model that represents the kinematics, dynamics, geometry, and actuation properties of robot 160. The robot model permits simulator 117 to simulate the physical behavior of robot 160 in response to robot actions 402, including joint movements, end-effector movements, and interactions with objects in the environment. In some embodiments, simulator 117 also models external factors such as gravity, collisions, contact forces, sensor noise, and/or the like, permitting realistic simulation of various skills. Simulator 117 generates robot states 401 which reflect updated observations, such as joint angles, gripper positions, camera images, force readings, and/or the like. Roll-out data 403 includes sequences of state-action pairs, which are used for training and evaluating robot control models 121.

Loss calculator 118 calculates behavior cloning loss 404 based on roll-out data 403 and demonstration data 123. As shown, loss calculator 118 includes, without limitation, a behavior cloning loss calculator 405. In some embodiments, loss calculator 118 uses behavior cloning loss calculator 405 to calculate behavior cloning loss 404. In various embodiments, behavior cloning loss 404 is calculated as the negative loglikelihood of the robot actions included in demonstration data 123 given the observed robot states 401 under the policy model 420 π_{ϕ}. In some examples, for each state-action pair (s,a) in the demonstration data 123 [symbol] , behavior cloning loss 404 is calculated as:

$${ℒ}_{BC} ( ϕ ) = {𝔼}_{( s , a ) ∼ 𝒟} [ - log {π}_{ϕ} ( a \vert s ) ] , \qquad ( Equation 1 )$$

where π_{ϕ}(a|s) is the probability that the base policy assigns to action a given state s. Equation 1 measures how well the base policy π_{ϕ} aligns with the demonstration trajectory included in demonstration data 123.

Model trainer 116 updates the parameters of policy models 420 based on behavior cloning loss 404. In various embodiments, model trainer 116 uses various optimization techniques such as stochastic gradient descent (SGD), adaptive moment estimation (Adam), and/or the like, to minimize behavior cloning loss 404 and adjust the parameters ϕ of policy models 420 accordingly. In some examples, model trainer 116 solves the following optimization problem:

$${ϕ}^{*} = arg {min}_{ϕ} {ℒ}_{BC} ( ϕ ) . \qquad ( Equation 2 )$$

For each training epoch, model trainer 116 computes the gradient of behavior cloning loss 404 with respect to ϕ. The parameters are then updated in the direction that reduces behavior cloning loss 404. Model trainer 116 updates the parameters of policy model 420 over multiple training epochs until one or more stopping criteria are met, such as the behavior cloning loss 404 converging, reaching a predefined number of training epochs, and/or the like.

### Training Residual Models Using Reinforcement Learning

FIG. 4B illustrates how the model trainer 116 of FIG. 1 trains residual models 421 using a scheduler 119, according to various embodiments. As shown, robot control model 121 uses the trained policy model 420 and the untrained residusamal model 421 to process robot states 401 and generates robot actions 402. Simulator 117 processes robot actions 402 and generates the next robot states 401 and roll-out data 407. Loss calculator 118 uses reinforcement learning reward calculator 411 to process roll-out data 407 and generate reinforcement learning reward 408. Model trainer 116 uses reinforcement learning module 410 to update the parameters of residual model 421. Scheduler 119 interacts with model trainer 116 and robot control models 121 to schedule training of residual models 421 during the reinforcement learning.

Robot control models 121 process robot states 401 and generate robot actions 402. As shown, robot control models 121 include, without limitation, the trained policy models 420 and residual models 421. In various embodiments, robot control model 121 generates robot actions 402 based on a policy

$${π}_{θ} ( s ) = {π}_{{ϕ}^{*}} ( s ) + {π}_{θ}^{+} ( s ) ,$$

where θ are the parameters of residual model 421 to be trained. In some embodiments, only the mean of the trained base policy is added to the residual policy.

Simulator 117 processes robot actions 402 and generates the next robot states 401 and roll-out data 407. Simulator 117 generates robot states 401, which reflect updated observations, such as joint angles, gripper positions, camera images, force readings, and/or the like. Roll-out data 403 includes sequences of state-action pairs, which are used for training and evaluating robot control models 121.

Loss calculator 118 processes roll-out data 407 and generates a reinforcement learning reward 408. As shown, loss calculator 118 includes, without limitation, a reinforcement learning reward calculator 411. In various embodiments, reinforcement learning reward calculator 411 evaluates the outcome of each robot action 402 based on skill-specific success criteria and assigns a numerical reward accordingly. In some embodiments, reinforcement learning reward 408 is sparse, such as providing a reward of 1 only upon successful completion of a skill (e.g., successfully placing a cup into a machine) and zero otherwise. In some embodiments, reinforcement learning reward 408 is dense, providing incremental rewards based on progress toward task goals (e.g., reducing positional error or maintaining alignment with a target object). In some embodiments, reinforcement learning reward 408 includes penalty terms, such as penalty terms for excessive movement, collisions, and/or the like.

Model trainer 116 uses reinforcement learning reward 408 to train residual models 421. As shown, model trainer 116 includes, without limitation, a reinforcement learning module 410. RL is a learning framework in which an agent (e.g., the fixed trained base policy plus the to-be-trained residual policy

$${π}_{θ} ( s ) = {π}_{{ϕ}^{*}} ( s ) + {π}_{θ}^{+} ( s ) )$$

interacts with an environment by selecting robot actions 402, observing the resulting robot states 401, and receiving reinforcement learning rewards 408 that reflect skill performance. The goal is to learn a policy that maximizes the expected cumulative reward over time. In some examples, the expected return under policy π_{θ} is defined as:

$$J ( {π}_{0} ) = {𝔼}_{τ ∼ {π}_{θ}} [ {\sum }_{t = 0}^{T} {γ}^{t} {r}_{t}^{i} ] , \qquad ( Equation 3 )$$

where τ=(s₀, a₀, s₁, a₁, . . . , s_{T}) is a trajectory generated by following policy π_{θ}, and rₜⁱ denotes the reinforcement learning reward 408 of skill i received at time step t. In some embodiments, due to the sparsity of reinforcement learning reward 408, reinforcement learning objective in Equation 3 can exhibit high variance, which could cause the policy π_{θ} to drift significantly from the base policy π_{ϕ*} trained via behavior cloning. The drift can result in the loss of useful behavior learned from demonstration data 123 and reduce overall training stability. In some embodiments, to mitigate the issue, reinforcement learning module 410 uses a Kullback-Leibler (KL) divergence penalty between the policy π_{θ} and the base policy π_{ϕ*}. The KL divergence penalty provides a soft constraint that constrains the output of the robot control model 121 to remain close to the base policy throughout the fine-tuning with RL process. In some examples, the final reinforcement learning objective used to guide RL training is described as

$${J}_{FT} ( θ ) = J ( {π}_{θ} ) - α {D}_{KL} ( {π}_{θ} ‖ {π}_{{ϕ}^{*}} ) , \qquad ( Equation 4 )$$

where J(π_{θ}) is the expected task reward obtained by following the policy π_{θ}, and D_{KL}(π_{θ}∥π_{ϕ*}) is the KL-divergence measuring how much the current policy deviates from the base policy. The KL term can be computed as:

$${D}_{KL} ( {π}_{θ} ‖ {π}_{{ϕ}^{*}} ) = {𝔼}_{( s , a ) ∼ {π}_{θ}} [ log \frac{{π}_{θ} ( a \vert s )}{{π}_{{ϕ}^{*}} ( a \vert s )} ] , \qquad ( Equation 5 )$$

The weighting factor α controls the strength of the KL divergence penalty term. In various embodiments, reinforcement learning module 410 applies any suitable RL algorithm, such as policy gradient, Q-learning, actor-critic techniques, and/or the like, to compute the gradient of the expected return with respect to θ and to update the residual model 421. In some embodiments, training continues until residual model 421 performance converges or meets a predefined threshold, such as reaching a maximum number of training epochs. Any technically feasible RL technique, including known RL algorithms, can be used in some embodiments. Advantageously, the RL permits the residual model to explore different ways to perform a skill, which can result in better performing robot control models than if only behavior cloning were used. Further, use of a base policy that is trained using behavior cloning enables efficient RL training by guiding the exploration process, which can result in higher quality robot control models.

Scheduler 119 interacts with model trainer 116 and robot control models 121 and schedules the training of residual models 421 using reinforcement learning. In various embodiments, scheduler 119 is implemented as a centralized control loop that coordinates a pool of TAMP workers, a shared status queue, and a sampling strategy. Each TAMP worker executes a TAMP planner in an environment instance. When a TAMP worker reaches a handoff section that requires reinforcement learning, the TAMP worker submits a tuple (i,j) to the status queue, where i identifies the worker and j identifies the section index. The worker then enters an idle state until the worker receives a command from scheduler 119. In some embodiments, the status queue is a first-in-first-out (FIFO) queue that tracks the availability of handoff sections from across all workers. In various embodiments, scheduler 119 continuously monitors the status queue. Upon retrieving an entry (i,j) from the status queue, scheduler 119 queries a strategy object, which provides the sampling strategy, to determine whether the section j is suitable for training. If the sampling strategy accepts the section, scheduler 119 initiates an RL episode with worker i. In some embodiments, the sampling strategy upsamples later sections so that later skills in a task, which may not be reached as frequently as earlier skills, are also learned. If the section is accepted, at each step t in the RL episode, scheduler 119 receives the current robot states 401 sₜ by calling observe( ) on the worker. Scheduler 119 then receives robot actions 402 aₜ˜π_{θ}(sₜ) using the residual policy model 421 under training. The robot actions 402 are sent back to the worker, which advances the environment in simulator 117 by calling step (aₜ). Scheduler 119 continues the process in a loop until the worker indicates the current section is done by returning done( )=True. In some embodiments, whether the current section is done depends on whether the skill corresponding to the current section has been completed in the worker, meaning the robot reached the goal condition for that handoff section (e.g., successfully placing a cup, inserting an object, or aligning with a fixture). In some embodiments, after the current section is solved, the worker sends the done( ) success notification to scheduler 119 and runs TAMP until reaching the next handoff section that requires further reinforcement learning. When the next handoff section is reached, the worker submits another tuple (i,j) to the status queue and then waits in the idle state until a command is received from scheduler 119 again. Whenever, on the other hand, the sampling strategy does not accept section j, scheduler 119 issues a reset command to worker i, prompting the worker to restart the TAMP until TAMP reaches a handoff section and submits a tuple (i,j) to the status queue. The rejection-and-reset mechanism prevents training on sections that could be too difficult for the current policy or not yet ready according to a curriculum logic. The execution flow of scheduler 119 can be expressed more formally as:

Algorithm 1: Scheduler
Procedure: Scheduler(Workers, StatusQueue, Policy, Strategy)

| | |
|---|---|
| 1 | while True do |
| 2 | (i, j) ← StatusQueue.pop( ) |
| 3 | if Strategy.accepts(j) then |
| 4 | while not Workers[i].done( ) do |
| 5 | s_obs ← Workers[i].observe( ) |
| 6 | a ← Policy.act(s_obs) |
| 7 | Workers[i].step(a) |
| 8 | else |
| 9 | Workers[i].reset( ) |

In some embodiments, the strategy used by scheduler 119 includes a curriculum learning mechanism. For example, in a sequential strategy, scheduler 119 accepts section j whenever the average success rate over all previous sections from 0 to j−1 exceeds a predefined threshold τ. In some examples, the acceptance condition in a sequential strategy can be described as:

$$\frac{1}{j} {\sum }_{k = 0}^{j - 1} SuccessRate ( k ) \geq τ . \qquad ( Equation 6 )$$

The curriculum permits the RL agent to train on simpler or earlier skills before progressing to more difficult skills, resulting in more stable and sample-efficient RL training. In some embodiments, scheduler 119 uses a permissive strategy which accepts all sections unconditionally, allowing scheduler 119 to optimize utilization of the workers but without any enforced learning progression. In some embodiments, scheduler 119 also improves the throughput of RL training of residual models 421 using parallelization. Whenever the TAMP planning time per worker is bounded by T seconds, each RL interaction step takes at least t seconds, and each handoff segment spans at least H steps, then scheduler 119 with n workers achieves a throughput of at least 1/t frames per second, provided n≥T/H. In contrast, a single-worker scheduler limited by sequential planning and interaction has a worst-case throughput of only H/(T+tH). When TAMP planning dominates interaction time, such as when T=k·tH for some constant k, scheduler 119 with n workers improves training speed by a factor of approximately k+1 compared to the single-worker baseline.

### Robot Control Using TAMP and Trained Robot Control Models

FIG. 5 is a more detailed illustration of the robot control application 146 of FIG. 1, according to various embodiments. As shown, robot control application 146 includes, without limitation, trained robot control models 121 and TAMP 122. Robot control application 146 processes sensor data 501 acquired via sensors 180 and task 502 received from one or more I/O devices to generate controls for robot 160 to perform at least part of task 502, which includes one or more skills.

In some embodiments, robot control application 146 controls robot 160 using a hybrid execution strategy, called Synergistic Planning, Imitation, and Reinforcement (SPIRE), based on TAMP 122 and trained robot control models 121. At each timestep, robot control application 146 receives sensor data 501 from sensors 180, including joint positions, end-effector pose, force and torque signals, visual observations, and/or the like, to estimate the current robot states s. Robot control application 146 then determines whether the current robot state satisfies the goal condition G of the current handoff section, where G represents the set of terminal robot states of a skill. Whenever s∈G, meaning the current skill has successfully completed, the control loop exits. Whenever the current skill goal has not yet been achieved and the skill is tagged as being TAMP-based, robot control application 146 uses a motion planner in TAMP 122 to generate robot actions \vec{a}=PLAN−TAMP(s,G), which returns a sequence of robot actions expected to guide robot 160 from the current robot states toward a terminal handoff section. Any technically feasible motion planner, including known motion planners, can be used in some embodiments. Whenever the robot actions are instead tagged as RL-based (e.g., a·type=“RL”), robot control application 146 uses a trained policy π=a·policy that can be one of trained robot control models 121 corresponding to the current skill. Robot control application 146 generates robot actions based on the trained policy and generates controls to robot 160 until the handoff goal G for that skill is reached. For robot actions that are not RL-based (e.g., a·type≠“RL”), robot control application 146 instead executes a trajectory τ=a·trajectory that is generated by the motion planner in TAMP 122, described above. The work flow of robot control application 146 can be described as:

Algorithm 2: SPIRE
procedure: SPIRE(G)

| | |
|---|---|
| 1 | while True do |
| 2 | s ← OBSERVE( ) |
| 3 | if s ∈ G then return True |
| 4 | \vec{a} ← PLAN − TAMP(s,G) |
| 5 | for a ∈ \vec{a} do |
| 6 | if a.type = “RL” then π ← a.policy |
| 7 | EXECUTE-POLICY (π) |
| 8 | break |
| 9 | else |
| 10 | τ ← a.trajectory |
| 11 | EXECUTE-TRAJECTORY (τ) |

In some embodiments, robot control application 146 uses various motion planning techniques, such as inverse kinematics and/or the like, to generate one or more controls based on the robot actions. The controls can include joint position commands, velocity commands, or torque commands, depending on the specific motion control architecture of robot 160. In some embodiments, robot control application 146 includes real-time feedback from sensors 180 to dynamically adjust the robot actions based on unexpected changes in the environment, such as the displacement of objects or obstacles. In some embodiments, robot control application 146 sends low-level motor commands to the actuators of robot 160 based on the controls, or sends commands based on the controls to a low-level controller that generates low-level motor commands, enabling precise execution of the controls.

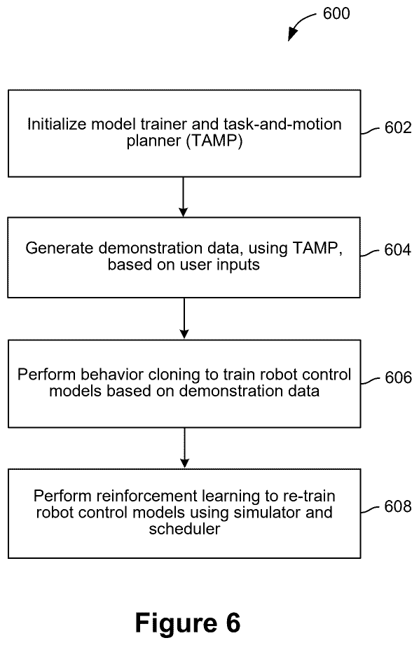

FIG. 6 is a flow diagram of method steps for training robot control models 121, according to various embodiments. Although the method steps are described in conjunction with the systems of FIGS. 1-5, persons skilled in the art will understand that any system configured to perform the method steps in any order falls within the scope of the present disclosure.

As shown, a method 600 begins with step 602, where model trainer 116 and TAMP 122 are initialized. In various embodiments, initializing model trainer 116 includes setting up the training configuration for reinforcement learning and behavior cloning. For example, model trainer 116 can initialize the learning rate (e.g., 1×10⁻⁴), discount factor (e.g., γ=0.99), and batch size (e.g., 256). In some embodiments, model trainer 116 initializes RL-specific settings, such as n-step returns (e.g., 3), action repeat (e.g., 1), and the number of seed frames (e.g., 4000) to influence sample efficiency and training stability. Model trainer 116 also initializes the neural network architecture of robot control models 121, such as the feature dimension (e.g., 50), hidden layer size (e.g., 1024), and network structure (e.g., convolutional neural network), and selects an optimizer (e.g., Adam) to update model weights during training. In some embodiments, model trainer 116 also initializes a penalty weight α used in the KL-divergence regularization as described in Equation 4. In some examples, the value of α (e.g., 0.1) can be set depending on the trade-off between exploration and adherence to demonstration behavior.

At step 604, trajectory recorder 115 generates demonstration data 123, using TAMP 122, based on user inputs 301. In various embodiments, TAMP 122 receives task 302 and demonstration skillset 304 and generates robot actions 305 based on robot states 306 to cause robot 160 to perform a skill which is not in demonstration skillset 304. Once TAMP 122 determines reaching a handoff section based on robot states 306 and/or states of other objects corresponding to completion of a skill in demonstration skillset 304, robot 160 receives user inputs 301 that cause robot 160 to perform a skill in demonstration skillset 304. Trajectory recorder 115 interacts with TAMP 122 and robot 160 and records trajectory 303 which is stored in demonstration data 123. Step 604 is described in greater detail in conjunction with FIG. 7.

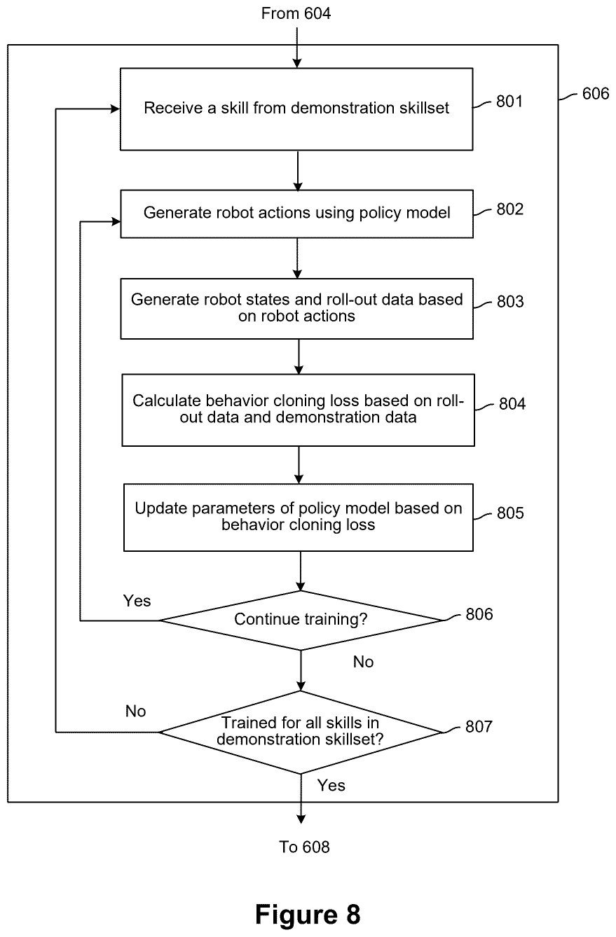

At step 606, model trainer 116 performs behavior cloning to train robot control models 121 based on demonstration data 123. In some embodiments, policy model 420 of robot control model 121 generates robot actions 402 based on robot states 401. Robot states 401 are applied to simulator 117 which generates the next robot states 401 and roll-out data 403. Loss calculator 118 uses behavior cloning loss calculator 405 to calculate a behavior cloning loss 404 based on roll-out data 403 and demonstration data 123. Model trainer 116 updates the parameters of policy model 420 based on behavior cloning loss 404. Step 606 is described in greater detail in conjunction with FIG. 8.

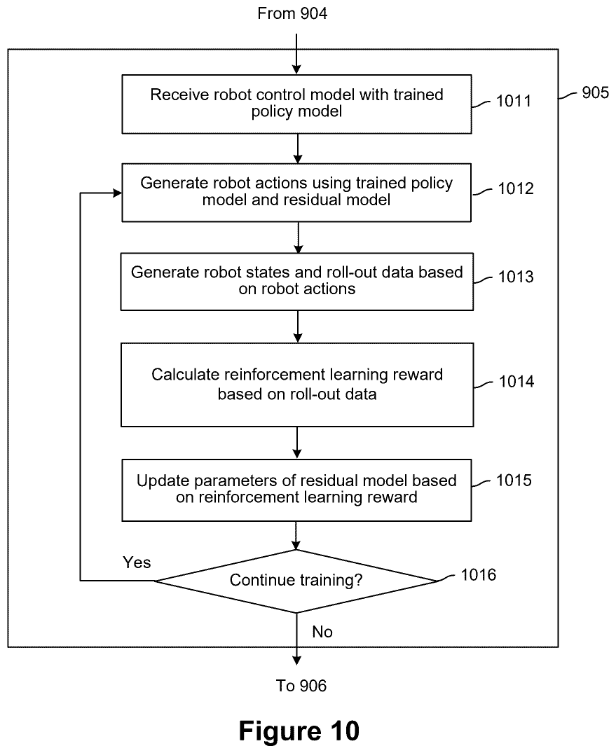

At step 608, model trainer 116 performs reinforcement learning to re-train robot control models 121 using simulator 117 and scheduler 119. In some embodiments, robot control model 121 uses the trained policy model 420 and the untrained residual model 421 to process robot states 401 and generates robot actions 402. Simulator 117 processes robot actions 402 and generates the next robot states 401 and roll-out data 407. Loss calculator 118 uses reinforcement learning reward calculator 411 to process roll-out data 407 and generate reinforcement learning reward 408. Model trainer 116 uses reinforcement learning module 410 to update the parameters of residual model 421. Scheduler 119 interacts with model trainer 116 and robot control models 121 to schedule training of residual models 421 during the reinforcement learning. Step 608 is described in greater detail in conjunction with FIGS. 9 and 10.

FIG. 7 is a flow diagram of method steps for generating demonstration data 123, according to various embodiments. Although the method steps are described in conjunction with the systems of FIGS. 1-5, persons skilled in the art will understand that any system configured to perform the method steps in any order falls within the scope of the present disclosure.

As shown, step 604 of the method 600 begins with step 701, where TAMP 122 determines current skill based on task 302. In some embodiments, TAMP 122 receives a task 302 and demonstration skillset 304. TAMP 122 processes robot states 306, task 302, and a demonstration skillset and generates robot actions 305 to cause robot 160 to perform a skill which is not in demonstration skillset 304 until reaching a hand off section.

At step 702, TAMP 122 checks whether skill is in a demonstration skillset. In some embodiments, TAMP 122 determines reaching a handoff section based on robot states 306 and/or states of other objects corresponding to completion of a skill which is not in demonstration skillset 304. Whenever TAMP 122 determines skill is in a demonstration skillset, step 604 of the method 600 proceeds to step 704. Whenever TAMP 122 determines skill is not in a demonstration skillset, step 604 of the method 600 proceeds to step 703.

At step 703, TAMP 122 causes robot 160 to perform a skill. In some embodiments, TAMP 122 processes robot states 306, task 302, and a demonstration skillset and generates robot actions 305 to cause robot 160 to perform a skill which is not in demonstration skillset 304 until reaching a hand off section. In some embodiments, TAMP 122 includes a model-based approach for synthesizing long-horizon robot behavior. TAMP 122 integrates discrete (e.g., symbolic) planning with continuous (e.g., motion) planning to plan hybrid discrete-continuous robot actions 305. In some embodiments, TAMP 122 uses a model of robot actions that a planner can apply and how the robot actions 305 modify the current robot states 306. Using the model, TAMP 122 can search over the space of plans to find a sequence of robot actions 305 and the associated parameters that satisfies a skill.

At step 704, robot 160 receives one or more user inputs 301. In various embodiments, user inputs 301 include teleoperation commands provided by a human operator using various input devices, such as a joystick, a VR controller, a kinesthetic teaching interface, and/or the like.

At step 705, TAMP 122 causes robot 160 to perform the skill based on user inputs 301. In some embodiments, whenever TAMP 122 determines a hand off section has been reached, robot 160 performs the skill in demonstration skillset 304 based on user inputs 301.

At step 706, trajectory recorder 115 records trajectory 303 of robot 160 performing the skill. In some embodiments, trajectory recorder 115 records trajectory 303 of robot 160, which is generated when user inputs 301 cause robot 160 to perform a skill in the demonstration skillset 304.

At step 707, trajectory recorder 115 stores trajectory 303 in demonstration data 123. In some embodiments, Trajectory recorder 115 stores trajectory 303 in demonstration data 123. In various embodiments, demonstration data 123 can be represented as

$$𝒟 = \{ \{ {( {s}_{t} , {a}_{t} )}_{t = 1}^{{H}_{i}} , {g}_{i} \} \}$$

where sₜ∈ [symbol] , aₜ∈ [symbol] and Hᵢ is the horizon, and gᵢ is the handoff section of the i-th trajectory 303.

At step 708, TAMP 122 determines whether task 302 is complete. Whenever TAMP 122 determines task 302 is complete, method 600 proceeds to step 606. Whenever TAMP 122 determines task 302 is not complete, step 604 of method 600 returns to step 701 to process the next skill.

FIG. 8 is a flow diagram of method steps for training policy models 420, according to various embodiments. Although the method steps are described in conjunction with the systems of FIGS. 1-5, persons skilled in the art will understand that any system configured to perform the method steps in any order falls within the scope of the present disclosure.

As shown, step 606 of the method 600 begins with step 801, where model trainer 116 receives a skill from demonstration skillset 304. In various embodiments, demonstration skillset 304 includes one or more skills that are impractical to manually model or to be performed by TAMP 122. In some embodiments, the skills that are impractical to manually model or be performed by TAMP 122 can be specified by a user.

At step 802, robot control model 121 generates robot actions 402 using policy model 420. In some embodiments, each robot control model 121 is associated with a skill from demonstration skillset 304 and is configured to generate robot actions 402 that guide robot 160 in performing that skill. In some examples, policy model 420 can be represented by a base policy π_{ϕ}(s) which maps robot states 401 to robot actions 402 and is parameterized by parameters ϕ.

At step 803, simulator 117 generates robot states 401 and roll-out data 403 based on robot actions 402. In various embodiments, simulator 117 includes a robot model that represents the kinematics, dynamics, geometry, and actuation properties of robot 160. The robot model permits simulator 117 to simulate the physical behavior of robot 160 in response to robot actions 402, including joint movements, end-effector movements, and interactions with objects in the environment. In some embodiments, simulator 117 also models external factors such as gravity, collisions, contact forces, sensor noise, and/or the like, permitting realistic simulation of various skills. Simulator 117 generates robot states 401 which reflect updated observations, such as joint angles, gripper positions, camera images, force readings, and/or the like. Roll-out data 403 includes sequences of state-action pairs, which are used for training and evaluating robot control models 121.

At step 804, loss calculator 118 calculates behavior cloning loss 404 based on roll-out data 403 and demonstration data 123. In some embodiments, loss calculator 118 uses behavior cloning loss calculator 405 to calculate behavior cloning loss 404. In various embodiments, behavior cloning loss 404 is calculated as the negative loglikelihood of the robot actions included in demonstration data 123 given the observed robot states 401 under the policy model 420 π_{ϕ}. In some examples, for each state-action pair (s,a) in the demonstration data 123 D, behavior cloning loss 404 is calculated as described in Equation 1 that measures how well the base policy π_{ϕ} aligns with the demonstration trajectory included in demonstration data 123.

At step 805, model trainer 116 updates parameters of policy model 420 based on behavior cloning loss 404. In various embodiments, model trainer 116 uses various optimization techniques such as SGD, Adam, and/or the like, to minimize behavior cloning loss 404 and adjust the parameters ϕ of policy models 420 accordingly. In some examples, model trainer 116 solves the optimization problem described in Equation 2. For each training epoch, model trainer 116 computes the gradient of behavior cloning loss 404 with respect ϕ. The parameters are then updated in the direction that reduces behavior cloning loss 404.

At step 806, model trainer 116 determines whether to continue training. In various embodiments, model trainer 116 updates the parameters of policy model 420 over multiple training epochs until one or more stopping criteria are met, such as the behavior cloning loss 404 converging, reaching a predefined number of training epochs, and/or the like. Whenever model trainer 116 determines not to continue training, step 606 of method 600 proceeds to step 807. Whenever model trainer 116 determines to continue training, step 606 of method 600 returns to step 802.

At step 807, model trainer 116 determines whether policy models 420 are trained for all skills in demonstration skillset 304. Whenever model trainer 116 determines policy models 420 are trained for all skills in demonstration skillset 304, method 600 proceeds to step 608. Whenever model trainer 116 determines policy models 420 are not trained for all skills in demonstration skillset 304, step 606 of method 600 returns to step 801 to receive the next skill in demonstration skillset 304.

FIG. 9 is a flow diagram of method steps for training residual models 421 using scheduler 119, according to various embodiments. Although the method steps are described in conjunction with the systems of FIGS. 1-5, persons skilled in the art will understand that any system configured to perform the method steps in any order falls within the scope of the present disclosure.

As shown, step 608 of method 600 begins with step 901, where scheduler 119 receives a sampling strategy, workers, and a status queue. In various embodiments, scheduler 119 is implemented as a centralized control loop that coordinates a pool of TAMP workers, a shared status queue, and a sampling strategy. Each TAMP worker executes a TAMP planner in an environment instance. When a TAMP worker reaches a handoff section, the TAMP worker submits a tuple (i,j) to the status queue, where i identifies the worker and j identifies the section index. In various embodiments, scheduler 119 continuously monitors the status queue.

At step 902, scheduler 119 pops the status queue. In some embodiments, the status queue is a FIFO queue that tracks the availability of handoff sections from across all workers, and an element is popped from the status queue.

At step 903, scheduler 119 determines whether to accept a section from the status queue based on the sampling strategy. In some embodiments, the sampling strategy upsamples later sections so that later skills in a task, which may not be reached as frequently as earlier skills, are also learned. In some embodiments, upon retrieving an entry (i,j) from the status queue, scheduler 119 queries a sampling strategy object to determine whether the section j is suitable for training. In some embodiments, the sampling strategy used by scheduler 119 includes a curriculum learning mechanism. For example, in a sequential strategy, scheduler 119 accepts section j whenever the average success rate over all previous sections from 0 to j−1 exceeds a predefined threshold τ. In some examples, the acceptance condition in a sequential strategy can be described by Equation 6. The curriculum permits that the RL agent trains on simpler or earlier skills before progressing to more difficult skills, resulting in more stable and sample-efficient RL training. In some embodiments, scheduler 119 uses a permissive strategy which accepts all sections unconditionally, allowing scheduler 119 to optimize utilization of the workers but without any enforced learning progression.

Whenever scheduler 119 determines not to accept the section from the status queue based on the sampling strategy, step 608 of method 600 proceeds to step 904. At step 904, scheduler 119 resets the worker. In some embodiments, whenever the sampling strategy does not accept section j, scheduler 119 issues a reset command to worker i, prompting the worker to restart the TAMP until TAMP reaches a new handoff section and the worker submits another tuple (i,j) to the status queue and then waits in an idle state until a command is received from scheduler 119.

On the other hand, whenever scheduler 119 determines to accept the section from the status queue based on the sampling strategy, step 608 of method 600 proceeds to step 905. At step 905, scheduler 119 causes reinforcement learning to be performed to train a residual model 421 for the section using simulator 117. In some embodiments, causing the reinforcement learning can include allocating a thread for executing a worker. In some embodiments, scheduler 119 initiates an RL episode with TAMP worker i. At each step t in the RL episode, scheduler 119 receives the current robot states 401 sₜ by calling observe( ) on the TAMP worker. Scheduler 119 then receives robot actions 402 aₜ˜π_{θ}(sₜ) using the residual policy model 421 under training. The robot actions 402 are sent back to the worker, which advances the environment in simulator 117 by calling step (aₜ). Step 905 is described in greater detail in conjunction with FIG. 10.

At step 906, scheduler 119 determines whether the worker is done with the current section. Scheduler 119 continues the process in a loop until the worker indicates the current section is solved by returning done( )=True. In some embodiments, at each step, scheduler 119 checks whether the skill has been completed in the worker, meaning the robot reached a goal condition for the skill. In some embodiments, after the current section is solved, the worker sends a success notification to scheduler 119 and runs TAMP until reaching the next handoff section that requires further reinforcement learning. When the next handoff section is reached, the worker submits another tuple (i,j) to the status queue and then waits in an idle state until a command is received from scheduler 119.

Whenever scheduler 119 determines the TAMP worker is not done with the current section, step 608 of method 600 returns to step 905. On the other hand, whenever scheduler determines the TAMP worker is done with the current section, step 608 of method 600 proceeds to step 907. At step 907, scheduler 119 determines whether the status queue is empty. In various embodiments, scheduler 119 continuously monitors the status queue. Whenever scheduler 119 determines the status queue is empty, method 600 terminates. Whenever scheduler 119 determines the status queue is not empty, step 608 of method 600 returns to step 902. Although step 907 is shown as occurring after step 906 for illustrative purposes, in some embodiments, scheduler 119 can pop the status queue multiple times and cause workers for selected sections to execute in parallel across different processors according to steps 902-906, as described above in conjunction with FIG. 4B.

FIG. 10 is the flow diagram of method steps for training a residual model using reinforcement learning, according to various embodiments. Although the method steps are described in conjunction with the systems of FIGS. 1-5, persons skilled in the art will understand that any system configured to perform the method steps in any order falls within the scope of the present disclosure.

As shown, step 905 begins with step 1011, where model trainer 116 receives robot control model 121 with trained policy model 420. In some embodiments, each robot control model 121 is associated with a skill from demonstration skillset 304 and is configured to generate robot actions 402 that guide robot 160 in performing that skill. Initially, each of robot control models 121 includes, without limitation, a trained policy model 420 and an untrained residual model 421. In some examples, each trained policy model 420 can be represented by a base policy π_{ϕ*}(s) which maps robot states 401 to robot actions 402 and is parameterized by trained parameters ϕ*. Residual model 421 can also be represented by a residual policy π_{θ}⁺(s) which maps robot states 401 to robot actions 402 and is parameterized by untrained parameters θ. Robot control model 121 then maps robot states 401 to robot actions 402 based on the base policy and the residual policy.

At step 1012, robot control model 121 generates robot actions 402 using trained policy model 420 and residual model 421. In various embodiments, robot control model 121 generates robot actions 402 based on a policy

$${π}_{θ} ( s ) = {π}_{{ϕ}^{*}} ( s ) + {π}_{θ}^{+} ( s ) ,$$

where θ are the parameters of residual model 421 to be trained. In some embodiments, only the mean of the trained base policy is added to the residual policy.

At step 1013, simulator 117 generates robot states 401 and roll-out data 407 based on robot actions 402. In some embodiments, simulator 117 generates robot states 401, which reflect updated observations, such as joint angles, gripper positions, camera images, force readings, and/or the like. Roll-out data 403 includes sequences of state-action pairs, which are used for training and evaluating robot control models 121.

At step 1014, loss calculator 118 calculates reinforcement learning reward 408 based on roll-out data 407. In various embodiments, loss calculator 118 uses reinforcement learning reward calculator 411 to evaluate the outcome of each robot action 402 based on skill-specific success criteria and assigns a numerical reward accordingly. In some embodiments, reinforcement learning reward 408 is sparse, such as providing a reward of 1 only upon successful completion of a skill and zero otherwise. In some embodiments, reinforcement learning reward 408 is dense, providing incremental rewards based on progress toward task goals. In some embodiments, reinforcement learning reward 408 includes penalty terms, such as penalty terms for excessive movement, collisions, and/or the like.

At step 1015, model trainer 116 updates parameters of residual model 421 based on reinforcement learning reward 408. In some embodiments, model trainer 116 includes a reinforcement learning module 410. RL is a learning framework in which an agent (e.g., the fixed trained base policy plus the to-be-trained residual policy

$${π}_{θ} ( s ) = {π}_{{ϕ}^{*}} ( s ) + {π}_{θ}^{+} ( s ) )$$

interacts with an environment by selecting robot actions 402, observing the resulting robot states 401, and receiving reinforcement learning rewards 408 that reflect skill performance. The goal is to learn a policy that maximizes the expected cumulative reward over time. In some examples, the expected return under policy π_{θ} is defined as given in Equation 3. In some embodiments, due to the sparsity of reinforcement learning reward 408, reinforcement learning objective in Equation 3 can exhibit high variance, which could cause the policy π_{θ} to drift significantly from the base policy π_{ϕ*} trained via behavior cloning. The drift can result in the loss of useful behavior learned from demonstration data 123 and reduce overall training stability. In some embodiments, to mitigate the issue, reinforcement learning module 410 uses a KL divergence penalty between the policy π_{θ} and the base policy π_{ϕ*}. The KL divergence penalty constrains the output of the robot control model 121 to remain close to the base policy throughout the fine-tuning with RL process. In some examples, the final reinforcement learning objective used to guide RL training is described as given in Equation 4. In various embodiments, reinforcement learning module 410 applies any suitable RL algorithm, such as policy gradient, Q-learning, actor-critic techniques, and/or the like, to compute the gradient of the expected return with respect to θ and to update the residual model 421.

At step 1016, model trainer 116 determines whether to continue training. In some embodiments, training continues until residual model 421 performance converges or meets a predefined threshold, such as reaching a maximum number of training epochs. Whenever model trainer 116 determines to continue training, step 905 returns to step 1012. Whenever model trainer 116 determines not to continue training, the method 900 proceeds to step 906.

FIG. 11 is the flow diagram of method steps for controlling robot 160, according to various embodiments. Although the method steps are described in conjunction with the systems of FIGS. 1-5, persons skilled in the art will understand that any system configured to perform the method steps in any order falls within the scope of the present disclosure.

As shown, a method 1100 begins with step 1101, where robot control application 146 receives sensor data 501 and task 502. In some embodiments, robot control application 146 receives sensor data 501 via sensors 180 and task 502 from one or more I/O devices.

At step 1102, robot control application 146 selects a skill from task 502. As described, task 502 can include multiple skills, and robot control application 146 sequentially selects skills and controls robot 160 to perform the selected skills.

At step 1103, robot control application 146 processes sensor data 501 using either TAMP 122 or a trained robot control model 121, to generate an action for robot 160 to perform at least part of the skill. In various embodiments, at each timestep, robot control application 146 processes sensor data 501 from sensors 180 to estimate the current robot state s. Whenever the robot actions are tagged as RL-based (e.g., a·type=“RL”), robot control application 146 uses a trained policy π including a base policy and a residual policy from one of trained robot control models 121 corresponding to the current skill. Robot control application 146 generates robot actions based on the trained policy and generates controls to robot 160 until the handoff goal G for that skill is reached. For robot actions that are not RL-based (e.g., a·type≠“RL”), robot control application 146 instead executes a trajectory τ=a·trajectory that is generated by a motion planner in TAMP 122. The work flow of robot control application 146 can be as described by Algorithm 2.

At step 1104, robot control application 146 generates controls for robot 160 to perform, based on the action, at least part of the skill. In some embodiments, robot control application 146 uses various motion planning techniques, such as inverse kinematics and/or the like, to generate one or more controls based on the robot actions. The controls can include joint position commands, velocity commands, or torque commands, depending on the specific motion control architecture of robot 160. In some embodiments, robot control application 146 includes real-time feedback from sensors 180 to dynamically adjust the robot actions based on unexpected changes in the environment, such as the displacement of objects or obstacles.

At step 1105, robot control application 146 causes robot 160 to move based on the controls. In some embodiments, robot control application 146 sends low-level motor commands to the actuators of robot 160 based on the controls, or sends commands based on the controls to a low-level controller that generates low-level motor commands, enabling precise execution of the controls.

At step 1106, if robot control application 146 determines that the skill has not been completed, then method 1100 returns to step 1103, where robot control application 146 processes additional sensor data 501 using either TAMP 122 or the trained robot control model 121, to generate another action for robot 160 to perform at least part of the skill. In some embodiments, robot control application 146 can determines whether the current robot state satisfies the goal condition G of the current handoff section, where G represents the set of terminal robot states of a skill in the demonstration skillset. Whenever s∈G, meaning the current skill has successfully completed, the control loop exits. As long as the current skill goal has not yet been achieved, robot control application 146 uses TAMP 122 or the trained robot control model 121 to generate robot actions.

On the other hand, if robot control application 146 determines at step 1106 that the skill has been completed, then method 1100 proceed directly to step 1107. At step 1107, if robot control application 146 determines that there are no more skills in the task, then method 1100 ends. On the other hand, if robot control application 146 determines that there are more skills in the task, then method 1100 returns to step 1102, where robot control application 146 selects a next skill from the task.

In sum, techniques are disclosed for controlling robots using TAMP and robot control models that are trained using behavior cloning and reinforcement learning. The robot control models are machine learning models, such as neural networks, that process robot states and generate robot actions to perform at least part of a robotic skill. Each robot control model includes a policy model that generates robot actions and a residual model that generates modifications to the robot actions output by the policy model. In some embodiments, TAMP is used to generate demonstration data based on user inputs. Given a robotic task and a demonstration skillset, TAMP divides the task into various skills and checks whether the current skill is in the demonstration skillset, which includes the set of skills for which one or more robot control models need to be trained. Whenever the skill is not in the demonstration skillset, TAMP causes the robot to perform the skill until reaching a handoff section, which implies that the next skill is in the demonstration skillset. Then, the robot receives one or more user inputs, which cause the robot to perform the skill in the demonstration skillset. A trajectory recorder records the trajectory of the robot, which is stored in the demonstration data. The foregoing process continues until the task is complete. In some embodiments, a model trainer uses the demonstration data to train the policy models included in the robot control models. For each skill in demonstration skillset, the model trainer uses a trajectory for that skill included in the demonstration data to train a policy model. In various embodiments, the robot control model generates robot actions which are applied within a simulator. The simulator generates the next robot state and roll-out data based on the robot actions. A loss calculator calculates a behavior cloning loss based on the roll-out data and the demonstration data, which includes robot states and robot actions, and the trajectory. The model trainer then iteratively updates the parameters of the policy model based on the calculated losses until one or more stopping criteria are met. The model trainer then trains another policy model for another skill until training for all skills in the demonstrations skillset have completed. In various embodiments, the model trainer uses the robot control model with the trained policy models to train residual models using reinforcement learning. During the reinforcement learning, the robot control model generates robot actions which are applied to the simulator. The simulator generates the next robot states and the roll-out data based on the robot actions. The loss calculation module uses a reinforcement learning reward calculator to calculate a reinforcement learning reward based on robot actions, robot state, and robot actions generated using the trained policy model. The model trainer then uses a reinforcement learning module to iteratively update the parameters of the residual model based on the calculated rewards until one or more stopping criteria are met. The reinforcement learning module can use a reward that includes a Kullback-Leibler (KL) divergence term that limits deviations of robot actions generated by the robot control model from the robot actions generated by the previously trained policy model. Once the residual models for all skills in the demonstration skillset are trained, the robot control models, which each include a trained policy model that generates robot actions and a trained residual model that generates modifications to the robot actions, can be used along with TAMP to process sensor data and a task, and generate actions to cause a robot to perform at least part of the task that includes multiple skills.

In some embodiments, the model trainer uses a scheduler to schedule training of robot control models during the reinforcement learning. In various embodiments, the scheduler receives a sampling strategy, one or more workers, and a status queue. Each worker includes a TAMP environment that performs skills not in the demonstration skillset by default and reports a section request to the status queue whenever TAMP reaches a handoff section. Each status queue element includes a worder identifier (ID) and a section ID. To begin with, the scheduler pops the status queue. The scheduler then checks whether a section from the status queue is acceptable based on the sampling strategy. Whenever the section is determined not to be acceptable, the scheduler resets the worker, thereby skipping reinforcement learning for that particular section. Otherwise, the scheduler interacts with the model trainer, which performs reinforcement learning to train the residual model for the section. The reinforcement learning continues until the worker indicates to the scheduler the completion of the skill, at which point the worker uses TAMP to perform a next skill, if any, until a handoff section is reached and the worker reports another section request to the status queue. The scheduler also checks whether the status queue is empty. Whenever the scheduler determines that the status queue is not empty, the scheduler pops the status queue again and repeats the process. Whenever the scheduler determines that the status queue is empty, the model trainer stores the trained residual models.

At least one technical advantage of the disclosed techniques relative to the prior art is that the disclosed techniques combine TAMP with behavior cloning and reinforcement learning in a synergistic framework that overcomes limitations of either approach alone. Unlike conventional RL techniques which require finely tuned, dense reward functions, the disclosed techniques restrict RL to predefined handoff sections determined by TAMP. The restriction simplifies reward design by allowing sparse, success-based rewards to be used. Another advantage of the disclosed techniques is that, rather than learning entire task behaviors end-to-end, the disclosed techniques use TAMP to handle routine skills included in the task, while reinforcement learning is used to fine-tune residual corrections for more challenging skills. The disclosed techniques also reduce the need for large, high-quality demonstration datasets by limiting the scope of behavior cloning to a subset of skills, where skills that are easier to model are delegated to TAMP. Yet another advantage of the disclosed techniques is that, by leveraging a scheduler that coordinates multiple TAMP workers and selectively allocates RL training opportunities to skills that are ready for training, the disclosed techniques permit scalable training for long-horizon tasks. These technical advantages provide one or more technological improvements over prior art approaches.
1. In some embodiments, a computer-implemented method for training one or more robot control models comprises performing, based on one or more demonstration trajectories of a robot performing one or more skills associated with a task, one or more training operations to generate one or more first trained machine learning models for controlling the robot, and performing one or more reinforcement learning operations using the one or more first trained machine learning models to generate one or more second trained machine learning models for controlling the robot.
2. The computer-implemented method of clause 1, wherein each first trained machine learning model included in the one or more first trained machine learning models is trained to control the robot to perform a different skill included in the one or more skills, and wherein each second trained machine learning model included in the one or more second trained machine learning models is trained to control the robot to perform a different skill included in the one or more skills.
3. The computer-implemented method of clauses 1 or 2, wherein each first trained machine learning model included in the one or more first trained machine learning models is trained to generate a base action to control the robot, and each second trained machine learning model included in the one or more second trained machine learning models is trained to generate a delta action that modifies the base action generated by a corresponding first trained machine learning model included in the one or more first trained machine learning models.
4. The computer-implemented method of any of clauses 1-3, further comprising generating the one or more demonstration trajectories based on one or more user inputs to control the robot via one or more input/output devices.
5. The computer-implemented method of any of clauses 1-4, wherein performing one or more training operations to generate the one or more first trained machine learning models comprises generating, using an untrained machine learning model, one or more robot actions, generating, based on the one or more robot actions and using a simulator, one or more state-action pairs, calculating, based on the one or more state-action pairs and at least one trajectory included in the one or more demonstration trajectories, a loss, and updating, based on the loss, one or more parameters of the untrained machine learning model.
6. The computer-implemented method of any of clauses 1-5, wherein performing one or more reinforcement learning operations to generate the one or more second trained machine learning models comprises generating, using a first trained machine learning model included in the one or more first trained machine learning models and an untrained machine learning model, one or more actions, generating, based on the one or more actions and using a simulator, one or more state-action pairs, calculating, based on the one or more state-action pairs, a reward, and updating, based on the reward, the one or more parameters of the untrained machine learning model to generate a second trained machine learning model included in the one or more second trained machine learning models.
7. The computer-implemented method of any of clauses 1-6, wherein the reward comprises at least one of a sparse reward of one upon successful completion of a first skill included in the one or more skills and zero otherwise, a dense reward based on progress toward one or more goals associated with the first skill, or one or more penalty terms for movements greater than a threshold and collisions.
8. The computer-implemented method of any of clauses 1-7, wherein performing one or more reinforcement learning operations comprises updating one or more parameters of an untrained machine learning model based on a Kullback-Leibler (KL) divergence term that penalizes differences between one or more first actions generated using a first trained machine learning model included in the one or more first trained machine learning models and one or more second actions generated using the first trained machine learning model and the untrained machine learning model.
9. The computer-implemented method of any of clauses 1-8, wherein performing one or more reinforcement learning operations comprises scheduling a plurality of workers based on a sampling strategy for sampling workers to execute and a queue that stores indications of workers that require scheduling, and executing the plurality of workers based on the scheduling to generate the one or more second trained machine learning models.
10. The computer-implemented method of any of clauses 1-9, further comprising receiving sensor data from one or more sensors, generating, based on the sensor data and using the one or more first trained machine learning models and the one or more second trained machine learning models, one or more actions, and causing the robot to perform one or more first movements based on the one or more actions.
11. In some embodiments, one or more non-transitory computer readable media store instructions that, when executed by one or more processors, cause the one or more processors to perform the steps of performing, based on one or more demonstration trajectories of a robot performing one or more skills associated with a task, one or more training operations to generate one or more first trained machine learning models for controlling the robot, and performing one or more reinforcement learning operations using the one or more first trained machine learning models to generate one or more second trained machine learning models for controlling the robot.
12. The one or more non-transitory computer-readable media of clause 11, wherein the instructions, when executed by the one or more processors, further cause the one or more processors to perform the step of generating the one or more demonstration trajectories based on one or more user inputs to control the robot via one or more input/output devices.
13. The one or more non-transitory computer-readable media of clauses 11 or 12, wherein performing one or more training operations to generate the one or more first trained machine learning models comprises generating, using an untrained machine learning model, one or more robot actions, generating, based on the one or more robot actions and using a simulator, one or more state-action pairs, calculating, based on the one or more state-action pairs and at least one trajectory included in the one or more demonstration trajectories, a loss, and updating, based on the loss, one or more parameters of the untrained machine learning model.
14. The one or more non-transitory computer-readable media of any of clauses 11-13, wherein the loss comprises a difference between one or more first robot actions generated using the untrained machine learning model and one or more second robot actions included in the one or more demonstration trajectories.
15. The one or more non-transitory computer-readable media of any of clauses 11-14, wherein performing one or more reinforcement learning operations to generate the one or more second trained machine learning models comprises generating, using a first trained machine learning model included in the one or more first trained machine learning models and an untrained machine learning model, one or more actions, generating, based on the one or more actions and using a simulator, one or more state-action pairs, calculating, based on the one or more state-action pairs, a reward, and updating, based on the reward, the one or more parameters of the untrained machine learning model to generate a second trained machine learning model included in the one or more second trained machine learning models.
16. The one or more non-transitory computer-readable media of any of clauses 11-15, wherein performing one or more reinforcement learning operations comprises updating one or more parameters of an untrained machine learning model based on a Kullback-Leibler (KL) divergence term that penalizes differences between one or more first actions generated using a first trained machine learning model included in the one or more first trained machine learning models and one or more second actions generated using the first trained machine learning model and the untrained machine learning model.
17. The one or more non-transitory computer-readable media of any of clauses 11-16, wherein the instructions, when executed by the one or more processors, further cause the one or more processors to perform the step of controlling the robot to perform one or more other skills associated with the task using a task and motion planner (TAMP).
18. The one or more non-transitory computer-readable media of any of clauses 11-17, wherein the instructions, when executed by the one or more processors, further cause the one or more processors to perform the steps of receiving sensor data from one or more sensors, generating, based on the sensor data and using the one or more first trained machine learning models and the one or more second trained machine learning models, one or more actions, and causing the robot to perform one or more first movements based on the one or more actions.
19. The one or more non-transitory computer-readable media of any of clauses 11-18, wherein the instructions, when executed by the one or more processors, further cause the one or more processors to perform the step of causing the robot to perform one or more second movements based on one or more motions generated using a motion planning technique.
20. In some embodiments, a system comprises one or more memories storing instructions, and one or more processors that are coupled to the one or more memories and, when executing the instructions, are configured to perform, based on one or more demonstration trajectories of a robot performing one or more skills associated with a task, one or more training operations to generate one or more first trained machine learning models for controlling the robot, and perform one or more reinforcement learning operations using the one or more first trained machine learning models to generate one or more second trained machine learning models for controlling the robot.
1. In some embodiments, a computer-implemented method for training one or more robot control models comprises scheduling a plurality of workers based on a sampling strategy for sampling workers to execute and a queue that stores indications of workers that require scheduling, and executing the plurality of workers based on the scheduling to generate a plurality of trained machine learning models for controlling a robot to perform a plurality of skills associated with a task.
2. The computer-implemented method of clause 1, wherein scheduling the plurality of workers comprises popping an element from the queue, determining, based on the sampling strategy, to accept a section indicated by the element, wherein the section corresponds to a first skill included in the plurality of skills, and causing a first worker included in the plurality of workers to perform one or more reinforcement learning operations to train a first machine learning model to perform the first skill.
3. The computer-implemented method of clauses 1 or 2, further comprising receiving, from the first worker, a notification that the first skill has been completed.
4. The computer-implemented method of any of clauses 1-3, wherein, after the first worker completes the first skill, the first worker completes a second skill included in the plurality of skills and adds another element to the queue.
5. The computer-implemented method of any of clauses 1-4, wherein the first worker completes the second skill using a task and motion planner (TAMP).
6. The computer-implemented method of any of clauses 1-5, wherein scheduling the plurality of workers comprises popping an element from the queue, determining, based on the sampling strategy, to not accept a section indicated by the element, wherein the section corresponds to a first skill included in the plurality of skills, and resetting a worker indicated by the element.
7. The computer-implemented method of any of clauses 1-6, wherein the sampling strategy accepts a section indicated by an element of the queue when an average success rate of all previous sections before the section exceeds a predefined threshold.
8. The computer-implemented method of any of clauses 1-7, wherein the sampling strategy accepts all sections indicated by elements of the queue unconditionally, wherein each section corresponds to a skill included in the plurality of skills.
9. The computer-implemented method of any of clauses 1-8, wherein the plurality of trained machine learning models are generated using reinforcement learning.
10. The computer-implemented method of any of clauses 1-9, further comprising receiving sensor data from one or more sensors, generating, based on the sensor data and using the plurality of trained machine learning models, one or more actions, and causing the robot to move based on the one or more actions.
11. In some embodiments, one or more non-transitory computer readable media store instructions that, when executed by one or more processors, cause the one or more processors to perform the steps of scheduling a plurality of workers based on a sampling strategy for sampling workers to execute and a queue that stores indications of workers that require scheduling, and executing the plurality of workers based on the scheduling to generate a plurality of trained machine learning models for controlling a robot to perform a plurality of skills associated with a task.
12. The one or more non-transitory computer-readable media of clause 11, wherein scheduling the plurality of workers comprises popping an element from the queue, determining, based on the sampling strategy, to accept a section indicated by the element, wherein the section corresponds to a first skill included in the plurality of skills, and causing a first worker included in the plurality of workers to perform one or more reinforcement learning operations to train a first machine learning model to perform the first skill.
13. The one or more non-transitory computer-readable media of clauses 11 or 12, wherein scheduling the plurality of workers comprises popping an element from the queue, determining, based on the sampling strategy, to not accept a section indicated by the element, wherein the section corresponds to a first skill included in the plurality of skills, and resetting a worker indicated by the element.
14. The one or more non-transitory computer-readable media of any of clauses 11-13, wherein the sampling strategy accepts a section indicated by an element of the queue when an average success rate of all previous sections before the section exceed a predefined threshold.
15. The one or more non-transitory computer-readable media of any of clauses 11-14, wherein the sampling strategy accepts all sections indicated by elements of the queue unconditionally, wherein each section corresponds to a skill included in the plurality of skills.
16. The one or more non-transitory computer-readable media of any of clauses 11-15, wherein the instructions, when executed by the one or more processors, further cause the one or more processors to perform the steps of receiving sensor data from one or more sensors, generating, based on the sensor data and using the plurality of trained machine learning models, one or more actions, and causing the robot to move based on the one or more actions.
17. The one or more non-transitory computer-readable media of any of clauses 11-16, wherein at least two of the plurality of workers are executed in parallel.
18. The one or more non-transitory computer-readable media of any of clauses 11-17, wherein the sampling strategy upsamples one or more sections corresponding to one or more later skills included in the plurality of skills.
19. The one or more non-transitory computer-readable media of any of clauses 11-18, wherein the plurality of trained machine learning models comprise a plurality of trained convolutional neural networks.
20. In some embodiments, a system comprises one or more memories storing instructions, and one or more processors that are coupled to the one or more memories and, when executing the instructions, are configured to schedule a plurality of workers based on a sampling strategy for sampling workers to execute and a queue that stores indications of workers that require scheduling, and execute the plurality of workers based on the scheduling to generate a plurality of trained machine learning models for controlling a robot to perform a plurality of skills associated with a task.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training one or more robot control models, the method comprising:
scheduling a plurality of workers based on a sampling strategy for sampling workers to execute and a queue that stores indications of workers that require scheduling; and
executing the plurality of workers based on the scheduling to generate a plurality of trained machine learning models for controlling a robot to perform a plurality of skills associated with a task.

2. The computer-implemented method of claim 1, wherein scheduling the plurality of workers comprises:
popping an element from the queue;
determining, based on the sampling strategy, to accept a section indicated by the element, wherein the section corresponds to a first skill included in the plurality of skills; and
causing a first worker included in the plurality of workers to perform one or more reinforcement learning operations to train a first machine learning model to perform the first skill.

3. The computer-implemented method of claim 2, further comprising receiving, from the first worker, a notification that the first skill has been completed.

4. The computer-implemented method of claim 2, wherein, after the first worker completes the first skill, the first worker completes a second skill included in the plurality of skills and adds another element to the queue.

5. The computer-implemented method of claim 4, wherein the first worker completes the second skill using a task and motion planner (TAMP).

6. The computer-implemented method of claim 1, wherein scheduling the plurality of workers comprises:
popping an element from the queue;
determining, based on the sampling strategy, to not accept a section indicated by the element, wherein the section corresponds to a first skill included in the plurality of skills; and
resetting a worker indicated by the element.

7. The computer-implemented method of claim 1, wherein the sampling strategy accepts a section indicated by an element of the queue when an average success rate of all previous sections before the section exceeds a predefined threshold.

8. The computer-implemented method of claim 1, wherein the sampling strategy accepts all sections indicated by elements of the queue unconditionally, wherein each section corresponds to a skill included in the plurality of skills.

9. The computer-implemented method of claim 1, wherein the plurality of trained machine learning models are generated using reinforcement learning.

10. The computer-implemented method of claim 1, further comprising:
receiving sensor data from one or more sensors;
generating, based on the sensor data and using the plurality of trained machine learning models, one or more actions; and
causing the robot to move based on the one or more actions.

11. One or more non-transitory computer-readable media storing instructions that, when executed by one or more processors, cause the one or more processors to perform the steps of:
scheduling a plurality of workers based on a sampling strategy for sampling workers to execute and a queue that stores indications of workers that require scheduling; and
executing the plurality of workers based on the scheduling to generate a plurality of trained machine learning models for controlling a robot to perform a plurality of skills associated with a task.

12. The one or more non-transitory computer-readable media of claim 11, wherein scheduling the plurality of workers comprises:
popping an element from the queue;
determining, based on the sampling strategy, to accept a section indicated by the element, wherein the section corresponds to a first skill included in the plurality of skills; and
causing a first worker included in the plurality of workers to perform one or more reinforcement learning operations to train a first machine learning model to perform the first skill.

13. The one or more non-transitory computer-readable media of claim 11, wherein scheduling the plurality of workers comprises:
popping an element from the queue;
determining, based on the sampling strategy, to not accept a section indicated by the element, wherein the section corresponds to a first skill included in the plurality of skills; and
resetting a worker indicated by the element.

14. The one or more non-transitory computer-readable media of claim 11, wherein the sampling strategy accepts a section indicated by an element of the queue when an average success rate of all previous sections before the section exceed a predefined threshold.

15. The one or more non-transitory computer-readable media of claim 11, wherein the sampling strategy accepts all sections indicated by elements of the queue unconditionally, wherein each section corresponds to a skill included in the plurality of skills.

16. The one or more non-transitory computer-readable media of claim 11, wherein the instructions, when executed by the one or more processors, further cause the one or more processors to perform the steps of:
receiving sensor data from one or more sensors;
generating, based on the sensor data and using the plurality of trained machine learning models, one or more actions; and
causing the robot to move based on the one or more actions.

17. The one or more non-transitory computer-readable media of claim 11, wherein at least two of the plurality of workers are executed in parallel.

18. The one or more non-transitory computer-readable media of claim 11, wherein the sampling strategy upsamples one or more sections corresponding to one or more later skills included in the plurality of skills.

19. The one or more non-transitory computer-readable media of claim 11, wherein the plurality of trained machine learning models comprise a plurality of trained convolutional neural networks.

20. A system comprising:
one or more memories storing instructions, and
one or more processors that are coupled to the one or more memories and,
when executing the instructions, are configured to:
schedule a plurality of workers based on a sampling strategy for sampling workers to execute and a queue that stores indications of workers that require scheduling, and
execute the plurality of workers based on the scheduling to generate a plurality of trained machine learning models for controlling a robot to perform a plurality of skills associated with a task.
